(19) United States
(12) Patent Application Publication
(10) Pub. No.: US 2020/0219049 A1
(43) Pub. Date: Jul. 9, 2020

(54) DELIVERY LOAD MANAGEMENT METHOD AND SYSTEM

(71) Applicant: Weilong Li, Chicago, IL (US)

(72) Inventor: Weilong Li, Chicago, IL (US)

(21) Appl. No.: 16/240,746

(22) Filed: Jan. 5, 2019

(51) Int. Cl. G06Q 10/08; G01C 21/34; G08G 1/0968; G08G 1/0967

(52) U.S. Cl. CPC G06Q 10/0832; G06Q 10/087; G06Q 10/0836; G08G 1/096775; G06Q 10/0838; G01C 21/3446; G08G 1/096811; G06Q 10/0833

(57) ABSTRACT

This invention concerns a delivery load management system capable of providing fast delivery to a plurality of delivery destinations, said delivery load management system comprises a central server; an algorithm; a group of registered users capable of placing order for delivery with said central server; a plurality of current ordered items ordered by said group of registered users; a plurality of past ordered items by said group of individual users; a central pick up location having at least said plurality of current ordered items and an expected item; a plurality of delivery vehicles; a plurality of delivery routes and a plurality of delivery regions determined by said central server according to said algorithm; and a central database. Said central server is capable of predicting a first new order from said group of registered users, and determines volume and identity of said expected item to be carried by each of said plurality of delivery vehicles according to said algorithm. Said algorithm can be improved and modified either manually or automatically.

### BACKGROUND OF THE INVENTION

### Field of the Invention

The present invention relates to a load management method and system that is capable of providing fast delivery to a plurality of delivery destinations. More specifically, my invention is primarily relates to a load management method and system that is capable of providing a prediction of receipt of an order for an expected item, and arrangement to load such expected item in advance to such order. The present invention provides a load management method and system that is capable of developing a database containing information related to users and orders received from thereof, including item identification, delivery destination, delivery window, and other related information. The present invention also provides a load management method and system that is capable of analyzing said database to come up with order habits of said users. The present invention further provides a load management method and system that is capable of making prediction of an order for a specific item from a specific user for a specific delivery destination within to a specific delivery window based on the analysis of said database according to an algorithm, and loading said specific item on a delivery vehicle before receipt of said order. The present invention still further provides a load management method and system that is capable of making prediction of a group of orders for a group of specific items from users for a specific delivery region within a specific delivery window based on the analysis of said database according to said algorithm, and loading said group of specific items on a delivery vehicle before receipt of said group of orders. The present invention still further provides a load management method and system that is capable of making prediction of a group of orders for a group of specific items from users for a plurality of specific delivery regions within a plurality of specific delivery windows based on the analysis of said database according to said algorithm, and loading said group of specific items on a plurality of delivery vehicles before receipt of said group of orders. The present invention still further provides a load management method and system that is capable of providing instructions to each delivery vehicles upon completion of delivery whether to pass on remaining loads to another delivery vehicle or return home with said remaining loads. The present invention still further provides a load management method and system that is capable of providing delivery route update upon receipt of order for said specific item to said delivery vehicle carrying such specific item. The present invention still further provides a load management method and system that is capable of improving and modifying said algorithm either manually or automatically based on information associated with said order, said orders, a part thereof, or a combination thereof.

### Description of the Prior Art

The transportation needs for delivery continue to grow in line with the growth of online orders. It is a difficult task to efficiently and effectively managing delivery. Various deliver load management methods and systems have been widely adopted to improve the delivery efficiency and effectiveness. Traditionally, the orders for various delivery items are gathered at first, then such delivery items are assigned to various delivery vehicles for delivery, and finally delivery vehicles deliver such delivery items to various destinations. Such process starts again for new orders received after the departure of delivery vehicles.

U.S. Pat. No. 7,225,981 issued to Jongebloed in June 2007 provides an agile, adaptive, globally deployable online network-centric autonomic supply chain management system that when triggered by a predictive/diagnostic condition management system, without user-maintainer intervention, autonomously authorizes a complete requisitioning cycle of supply chain assets to warfighters with unprecedented criticality of speed. A requisitioning cycle is comprised of: (1) asset issue authorization to a vehicle requester (2) retrograde [return] of repairable to depot and (3) replenishment [resupply] of drawn inventory. It also autonomically provides global total asset visibility of the asset(s) of interest and a tempo surge-priority ranking with a calm-down functions. The system operates in either default autonomic mode or a user activated semi-autonomic mode. In either mode of operation a requisition cycle is accomplished autonomically by selection of the most affordable transportation that ensures delivery of an asset to a user in accordance with contractually specified time-definite delivery standards. The system's material delivery performance effectiveness percentage rate is archived for billing purposes and monitoring system performance metrics. The system almost eliminates SCM administration personpower requirements. It accelerates the entire logistics supply pipeline, resulting in higher annual inventory turn-rates thus permitting inventory levels to be reduced and smaller wartime pack up kits thereby lowering lifetime total operating costs. Smaller pack up kits reduces the logistics footprint and thus the number of cargo aircraft required to deploy a unit.

U.S. Pat. No. 7,246,009 issued to Hamblen et al. in July 2007 provides a resource management system for tracking the location and status of, and managing, trucks going to and from batch plants and jobsites. Vehicle-mounted sensors communicate delivery status information via a wireless network. Status and performance data can be reviewed in real time to allow a dispatcher to efficiently manage the truck fleet. Electronic tickets and exception reports are provided.

U.S. Pat. No. 7,574,365 issued to Miller et al. in August 2009 discloses a direct delivery of consumer products bypassing retailer's warehouses. Embodiments of the present invention provide an end-to-end solution for direct store delivery. A direct store delivery order may be generated based on one or more received customer orders. Vehicle space optimization instructions may be generated based on one or more products to be delivered based on the one or more received orders. An order to retrieve the one or more products and an order to load the one or more products on to a transport vehicle based on the vehicle space optimization instructions may be generated. A travel route for the transport vehicle for delivering the one or more products to customers may be provided.

U.S. Pat. No. 7,949,612 issued to David in May 2011 discloses a method of optimizing log truck productivity that utilizes technology allowing the entry of log truck orders from the field. The invention generally seeks to improve productivity by (1) minimizing the distances log trucks drive with empty loads and (2) improving coordination between groups of log truck divers and groups of log loaders to allow for more efficient cross-servicing between the parties. Using the load input deice, a loader operator in the field enters a “load ticket” that specifies a mill destination, desired pickup time for the truck to arrive at the login site and a desired trailer configuration type. This order is transmitted to a server where it is then receive into a centralized application or server. A computer running optimization software can match the load with available trucks or trucks about to become available.

U.S. Pat. No. 8,374,927 issued to Roberts et al. in February 2013 discloses an invention that automates the process of receiving transportation documentation and producing advance loading manifests therefrom to optimize load planning and dynamic product shipment and delivery control. Methods provide for receipt of the transportation documentation initial preparation, and transmission of the documentation from on board a vehicle or while the vehicle is in transit.

U.S. Pat. No. 8,416,067 issued to Davidson et al. in April 2013 provides a fleet management system for capturing, storing, and analyzing telematics data to improve fleet management operations. The fleet management system may be used, for example, by a shipping entity (e.g., a common carrier) to capture telematics data from a plurality of vehicle sensors located on various delivery vehicles and to analyze the captured telematics data. In particular, various embodiments of the fleet management system are configured to analyze engine idle data in relation to other telematics data in order to identify inefficiencies, safety hazards, and theft hazards in a driver's delivery process. The fleet management system may also be configured to assess various aspects of vehicle performance, such as vehicle travel delays and vehicle speeds. These analytical capabilities allow the fleet management system to assist fleer managing entities, or other entities, in analyzing driver performance, reducing fuel and maintenance costs, and improving route planning.

U.S. Pat. No. 8,799,180 issued to Roberts et al. in August 2014 discloses an invention that automates the process of receiving transportation documentation and producing advance loading manifests therefrom to optimize load planning and dynamic product shipment and delivery control. Methods provide for receipt of the transportation documentation, initial preparation, and transmission of the documentation from on board a vehicle or while the vehicle is in transit.

U.S. Pat. No. 8,896,430 issued to Davidson et al. in November 2014 provides a fleet management system for capturing, storing, and analyzing telematics data to improve fleet management operations. The fleet management system may be used, for example, by a shipping entity (e.g., a common carrier) to capture telematics data from a plurality of vehicle sensors located on various delivery vehicles and to analyze the captured telematics data. In particular, various embodiments of the fleet management system are configured to analyze engine idle data in relation to other telematics data in order to identify inefficiencies, safety hazards, and theft hazards in a drivers delivery process. The fleet management system may also be configured to assess various aspects of vehicle performance, such as vehicle travel delays and vehicle speeds. These analytical capabilities allow the fleet management system to assist fleet managing entities, or other entities, in analyzing driver performance, reducing fuel and maintenance costs, and improving route planning.

U.S. Pat. No. 9,165,319 issued to Henry in October 2015 discloses an invention of a technique and method for vehicle information delivery and management, which includes receiving, by a management module of a service provider manager associated with a service provider, a notification from an application executing on a client device of an end user that vehicle data corresponding to a vehicle being viewed by the end user on a premises of the service provider has been displayed to the end user; storing, by the management module, the vehicle data corresponding to the viewed vehicle; and storing, by the management module, a time that the vehicle was viewed by the end user.

U.S. Pat. No. 9,324,198 issued to Davidson et al. in Apr. 2016 provides a fleet management system for capturing, storing, and analyzing telematics data to improve fleet management operations. The fleet management system may be used, for example, by a shipping entity (e.g. a common carrier) to capture telematics data from a plurality of vehicle sensors located on various delivery vehicles and to analyze the captured telematics data. In particular, various embodiments of the fleet management system are configured to analyze engine idle data in relation to other telematics data in order to identify inefficiencies, safety hazards, and theft hazards in a driver's delivery process. The fleet management system may also be configured to assess various aspects of vehicle performance, such as vehicle travel delays and vehicle speeds. These analytical capabilities allow the fleet management system to assist fleet managing entities, or other entities, in analyzing driver performance, reducing fuel and maintenance costs, and improving route planning.

U.S. Pat. No. 9,472,030 issued to Davidson et al. in October 2016 provides a fleet management system for capturing, storing, and analyzing telematics data to improve fleet management operations. The fleet management system may be used, for example, by a shipping entity (e.g. a common carrier) to capture telematics data from a plurality of vehicle sensors located on various delivery vehicles and to analyze the captured telematics data. In particular, various embodiments of the fleet management system are configured to analyze engine idle data in relation to other telematics data in order to identify inefficiencies, safety hazards, and theft hazards in a driver's delivery process. The fleet management system may also be configured to assess various aspects of vehicle performance, such as vehicle travel delays and vehicle speeds. These analytical capabilities allow the fleet management system to assist fleet managing entities, or other entities, in analyzing driver performance, reducing fuel and maintenance costs, and improving route planning.

U.S. Pat. No. 9,552,564 issued to Martenis in January 2017 describes aspects of an autonomous delivery transportation network for the delivery of items. The network includes a central management system that directs the operation of a network of vehicles for delivering items. In one embodiment, the system receives a request for transportation including a pickup location, a delivery location, and item attribute data. The system analyzes the existing service routes of vehicles in the network to identify a vehicle compatible with the request. The system also estimates a delay to the existing service route of the vehicle with reference to the pickup and delivery locations and, when determining that the delay is acceptable, assigns the vehicle to the service the request. When determining that the delay is unacceptable, the system may dispatch a new vehicle to join the network. The system may also communicate various aspects of service, such as estimated pickup and/or drop off times, to client devices.

U.S. Pat. No. 9,704,303 issued to Davidson et al. in July 2017 discloses a fleet management system for capturing, storing, and analyzing telematics data to improve fleet management operations. The fleet management system may be used, for example, by shipping entity (e.g., a common carrier) to capture telematics data from a plurality of vehicle sensors located on various delivery vehicles and to analyze the captured telematics data. In particular, various embodiments of the fleet management system are configured to analyze engine idle data in relation to other telematics data in order to identify inefficiencies, safety hazards, and theft hazards in a driver's delivery process. The fleet management system may also be configured to assess various aspects of vehicle performance, such as vehicle travel delays and vehicle speeds. These analytical capabilities allow the fleet management system to assist fleet managing entities, or other entities, in analyzing driver performance, reducing fuel and maintenance costs, and improving route planning.

The prior arts do not disclose any invention related to a load management method and system that is capable of developing a database containing information related to users and orders received from thereof, including item identification, delivery destination, delivery window, and other related information. The prior arts do not disclose any invention related to a load management method and system that is capable of analyzing said database to come up with order habits of said users. The prior arts do not disclose any invention related to a load management method and system that is capable of making prediction of an order for a specific item from a specific user for a specific delivery destination within to a specific delivery window based on the analysis of said database according to an algorithm, and loading said specific item on a delivery vehicle before receipt of said order. The prior arts do not disclose any invention related to a load management method and system that is capable of making prediction of a group of orders for a group of specific items from users for a specific delivery region within a specific delivery window based on the analysis of said database according to said algorithm, and loading said group of specific items on a delivery vehicle before receipt of said group of orders. The prior arts do not disclose any invention related to a load management method and system that is capable of making prediction of a group of orders for a group of specific items from users for a plurality of specific delivery regions within a plurality of specific delivery windows based on the analysis of said database according to said algorithm, and loading said group of specific items on a plurality of delivery vehicles before receipt of said group of orders. The prior arts do not disclose any invention related to a load management method and system that is capable of providing instructions to each delivery vehicles upon completion of delivery whether to pass on remaining loads to another delivery vehicle or return home with said remaining loads. The prior arts do not disclose any invention related to a load management method and system that is capable of providing delivery route update upon receipt of order for said specific item to said delivery vehicle carrying such specific item. The prior arts do not disclose any invention related to a load management method and system that is capable of improving and modifying said algorithm either manually or automatically based on information associated with said order, said orders, a part thereof, or a combination thereof.

What is needed then is a load management method and system that is capable of providing fast delivery to a plurality of delivery destinations. More specifically, what is needed is a load management method and system that is capable of providing a prediction of receipt of an order for an expected item, and arrangement to load such expected item in advance to such order.

Accordingly, it is a principal objective of my invention to provide a load management method and system that is capable of developing a database containing information related to users and orders received from thereof, including item identification, delivery destination, delivery window, and other related information.

It is a further objective of my invention to provide a load management method and system that is capable of analyzing said database to come up with order habits of said users.

It is a still further objective of my invention to provide a load management method and system that is capable of making prediction of an order for a specific item from a specific user for a specific delivery destination within to a specific delivery window based on the analysis of said database according to an algorithm, and loading said specific item on a delivery vehicle before receipt of said order.

It is a still further objective of my invention to provide a load management method and system that is capable of making prediction of a group of orders for a group of specific items from users for a specific delivery region within a specific delivery window based on the analysis of said database according to said algorithm, and loading said group of specific items on a delivery vehicle before receipt of said group of orders.

It is a still further objective of my invention to provide a load management method and system that is capable of making prediction of a group of orders for a group of specific items from users for a plurality of specific delivery regions within a plurality of specific delivery windows based on the analysis of said database according to said algorithm, and loading said group of specific items on a plurality of delivery vehicles before receipt of said group of orders.

It is a still further objective of my invention to provide a load management method and system that is capable of providing instructions to each delivery vehicles upon completion of delivery whether to pass on remaining loads to another delivery vehicle or return home with said remaining loads.

It is a still further objective of my invention to provide a load management method and system that is capable of providing delivery route update upon receipt of order for said specific item to said delivery vehicle carrying such specific item.

It is a still further objective of my invention to provide a load management method and system that is capable of improving and modifying said algorithm either manually or automatically based on information associated with said order, said orders, a part thereof, or a combination thereof.

Other objects of my invention, as well as particular features, elements, and advantages thereof, will be elucidated in, or apparent from, the following description and the accompanying drawing figures.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to my present invention, I have provided a delivery load management system capable of providing fast delivery to a plurality of delivery destinations, said delivery load management system comprises a central server, said central server being an independent server or a plurality of decentralized servers connected through internet; an order input end, said order input end being an independent order input end or a plurality of decentralized order input ends, said order input end being remotely coupled with and administrated by said central server; an individual user, said individual user being a single individual user or a group of individual users, each of whom being able to input order data through said order input end, said order data containing information about said individual user, an ordered item, said ordered item being a single item or a plurality of items, a delivery destination, said delivery destination being a single delivery destination or a plurality of delivery destination, associated with said single item or each of said plurality of items, a delivery time window associated with said single item or each of said plurality of items, and similar; a central display end, said central display end being a single central display end or a plurality of central display ends, said central display end being capable of display said order data to a central administrator, said central administrator being a single central administrator or a group of central administrators; a central database, said central database being a single central database or a plurality of central database, said central database containing said order data and being administrated by said central server; a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm; a central pick up location, said central pick up location being a single pick up location or a plurality of single pick up locations, each of which having said ordered item, or a part thereof, said central pick up location being administrated by said central server; a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm; an on-board delivery load management system associated with said delivery vehicle, said on-board delivery load management system being remotely coupled with said delivery load management system and administrated by said central server; an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof; an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof; an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof; an on-board telecommunication apparatus associated with said delivery vehicle, said on-board telecommunication apparatus capable of synchronizing and updating information between said on-board database and said central database in real-time; and an on-board GPS device associated with said delivery vehicle, said on-board GPS device capable of providing real-time location information of said delivery vehicle to said on-board database.

Said first preferred delivery route provides a most efficient route for said delivery vehicle to pick up said ordered item and said second item from said central pick up location and deliver said ordered item to said delivery destination based on analysis of said central database by said central server.

Said central server predicts a receipt of a new order, from said individual user, within a per-defined period of time after said delivery vehicle left said central pick up location with said ordered item and said second item, for said second item with a second delivery destination, said second delivery destination being within a pre-defined parameter from, en route to, or return from, said delivery destination at a second delivery time window, said second delivery time window being close to or within said delivery time window, based on analysis of said central database according to said second pre-defined algorithm.

Said central server receives said new order within said pre-defined period of time, updates said central database, modifies said first preferred delivery route to a second preferred delivery route based on analysis of said central database, said on-board database, or a combination thereof, according to said first pre-defined algorithm.

Said first pre-defined algorithm can be improved and modified either manually by said central administrator or automatically by said central server based on information associated with said on-board database, said central database, or a combination thereof.

Said second-predefined algorithm can be improved and modified either manually by said central administrator or automatically by said central server based on information associated with said new order, said pre-defined period of time, said second delivery location, said second delivery time window, said on-board database, said central database, or a combination thereof.

According to my present invention, I have also provided a delivery load management method capable of providing fast delivery to a plurality of delivery destinations, said delivery load management method comprises

providing a central server;

establishing a central database, said central database being administrated by said central server;

registering a plurality of users to said central server, each user of said plurality of users capable of placing orders for a plurality of delivery items, each of said plurality of delivery items being associated with a delivery location and a delivery time window, said plurality of delivery items including at least a first delivery item, said first delivery item being associated with a first delivery location and a first delivery time window, said first delivery item being a single first delivery item or a plurality of first delivery items, each of which being identical, different, or a combination thereof, and a second delivery item, said second delivery item being associated with a second delivery location and a second delivery time window, said second delivery item being a single second delivery item or a plurality of second delivery items, each of which being identical, different, or a combination thereof;

receiving said orders by said central server, said central server modifying said central database based on information related to said orders according to an algorithm;

registering a central pick up location to said central server, said central pick up location being a single central pick up location or a plurality of central pick up locations, said central pick up location having said plurality of delivery items or a part thereof and a plurality of expected delivery items, or a part thereof, said plurality of expected delivery items including at least a first expected delivery item, said first expected delivery item being associated with a first expected delivery location, said first expected delivery location being within proximity of, en route to, or return from said first delivery location, and a first expected delivery time window, said first expected delivery time window being within or close to said first delivery time window, and a second expected delivery item, said second expected delivery item being associated with a second expected delivery location, said second expected delivery location being within proximity of, en route to, or return from said second delivery location, and a second expected delivery time window, said second expected delivery time window being within or close to said second delivery time window;

registering a plurality of delivery vehicles to said central server, said plurality of delivery vehicles including at least a first delivery vehicle and a second delivery vehicle, said plurality of delivery vehicles being remotely coupled with and administrated by said central server;

picking up said at least one of said plurality of delivery items and at least one of said plurality of expected delivery items by at least one of said plurality of delivery vehicles determined and administrated by said central server, said first delivery vehicle picking up said first delivery item and said first expected delivery item, said second delivery vehicle picking up said second delivery item and said second expected delivery item, from said central pick up location;

delivering said at least one of said plurality of delivery items by at least one of said plurality of delivery vehicles to said delivery location within said delivery time window, said first delivery vehicle delivering said first delivery item to said first delivery location, said second delivery vehicle delivering said second delivery item to said second delivery location;

receiving new orders, said new orders including at least said first expected delivery item with said first expected delivery location within said first expected delivery time window, from at least one of said plurality of users by said central server, said central server modifying said central database based on information related to said new orders according to said algorithm; and

delivering said first expected delivery item to said first expected delivery location within said first expected delivery time window.

Said first delivery item and said second delivery item are identical. Said orders and said new orders are identical. Said plurality of delivery items or a part thereof and said plurality of expected delivery items or a part thereof are identical. Said first expected delivery item and said second expected delivery item are identical.

Said central server assigns at least one of said plurality of delivery items and at least one of said plurality of expected delivery items to at least one of said plurality of delivery vehicles based on analysis of said central database according to said algorithm.

Said central server assigns said first delivery item and said first expected delivery item to said first deliver vehicle, and said second delivery item and said second expected delivery item to said second delivery vehicle based on analysis of said central database according to said algorithm.

Said central server determines whether to request said second delivery vehicle to pass on said second expected delivery item to said first delivery vehicle upon completion of delivery of said second delivery item by said second delivery vehicle based on analysis of said central database according to said algorithm.

Said central server assigns at least one of said plurality of delivery items and at least one of said plurality of expected delivery items to at least one of said plurality of delivery vehicles based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

Said central server assigns said first delivery item and said first expected delivery item to said first deliver vehicle, and said second delivery item and said second expected delivery item to said second delivery vehicle based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

Said central server determines whether to request said second delivery vehicle to pass on said second expected delivery item to said first delivery vehicle upon completion of delivery of said second delivery item by said second delivery vehicle based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

Said central server modifies said algorithm based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof.

The present invention can be used in association with either a land-based or an air-based delivery network. The present invention can be used to analyze a specific user's past purchasing habit, past delivering habit, and other past indication related thereof. The present invention can also be used to predict said user's future purchasing habit, future delivering habit, and other future indication related thereof. The present invention can further be used to analyze a group of users' past purchasing habits, past delivering habits, and other past indications related thereof. The present invention can still further be used to predict said group of users' future purchasing habits, future delivering habit, and other future indications related thereof.

Further embodiments, features, and advantages of the present invention, as well as the structure and operation of various embodiments of the present invention, are described in detail below with reference to accompanying drawings.

Other technical advantages will be readily apparent to one skilled in the art from the following figures, descriptions and claims. Moreover, while specific advantages have been enumerated above, various embodiments may include all, some or one of the enumerated advantages.

Embodiments may be implemented as a computer, a computer process, a computing system or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

### DESCRIPTION OF THE DRAWINGS

Other features of my invention will become more evident from a consideration of the following detailed description of my patent drawings, as follows:

FIG. 1 is a structure demonstration drawing of a first preferred embodiment of a delivery load management system and method.

FIG. 2 is a structure demonstration drawing of a second preferred embodiment of a delivery load management system and method.

FIG. 3 is a structure demonstration drawing of a third preferred embodiment of a delivery load management system and method.

### DETAILED DESCRIPTION OF THE PREFERRED EMBODIMENT

Various embodiments are described more fully below with reference to the accompanying drawings, which form a part hereof, and which show specific embodiments for practicing the embodiments described herein. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems, or devices. Accordingly, embodiments may take the form of a hardware implementation, an entirely software implementation or an implementation combing software and hardware aspects.

Referring now to the drawings, my invention concerns a delivery load management system and method capable of providing fast delivery to a plurality of delivery destinations.

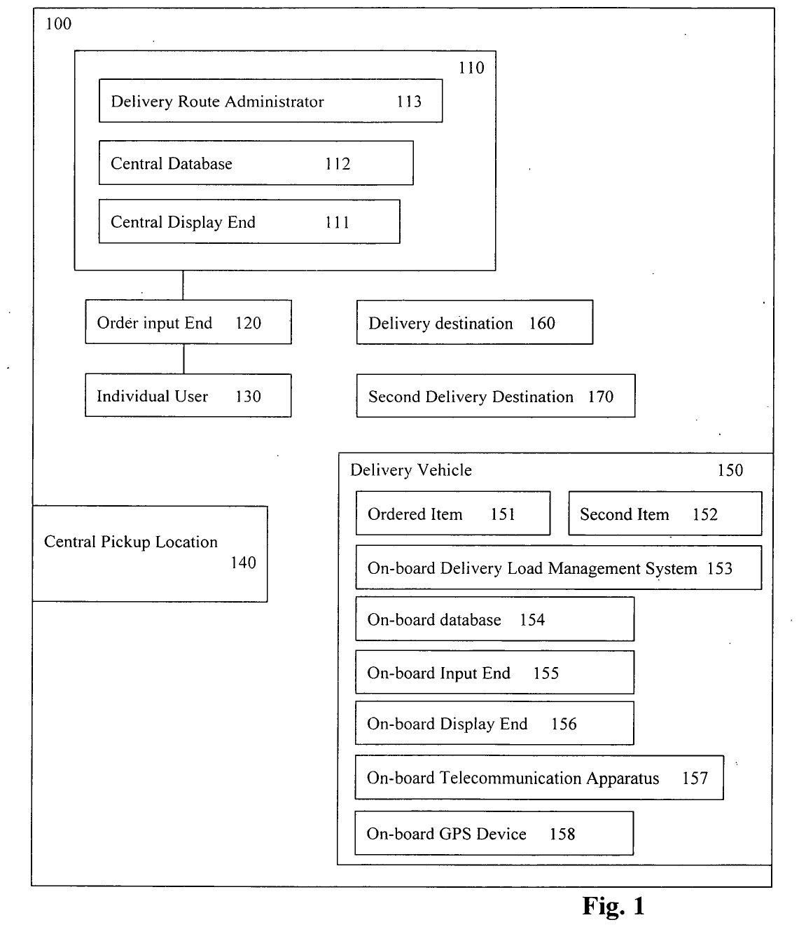

Referring now to FIG. 1, which is a structure demonstration drawing of a first preferred embodiment of a delivery load management system and method. Said delivery load management system 100, comprises a central server 110, said central server 110 being an independent server or a plurality of decentralized servers connected through internet; an order input end 120, said order input end 120 being an independent order input end or a plurality of decentralized order input ends, said order input end 120 being remotely coupled with and administrated by said central server 110; an individual user 130, said individual user 130 being a single individual user or a group of individual users, each of whom being able to input order data through said order input end 120, said order data containing information about said individual user 130, an ordered item 151, said ordered item 151 being a single item or a plurality of items, a delivery destination 160, said delivery destination 160 being a single delivery destination or a plurality of delivery destination, associated with said single item or each of said plurality of items, a delivery time window associated with said single item or each of said plurality of items, and similar; a central display end 111, said central display end 111 being a single central display end or a plurality of central display ends, said central display end 111 being capable of display said order data to a central administrator, said central administrator being a single central administrator or a group of central administrators; a central database 112, said central database 112 being a single central database or a plurality of central database, said central database 112 containing said order data and being administrated by said central server 110; a delivery route administrator 113, said delivery route administrator 113 being a single delivery route administrator or a plurality of delivery route administrators, said delivery route administrator 113 capable of generating a first preferred delivery route for delivery of said ordered item based on analysis of said central database 112 by said central server 110 according to a first pre-defined algorithm; a central pick up location 140, said central pick up location 140 being a single pick up location or a plurality of single pick up locations, each of which having said ordered item, or a part thereof, said central pick up location 140 being administrated by said central server 110; a delivery vehicle 150, said delivery vehicle 150 being a single delivery vehicle or a plurality of delivery vehicles, said delivery vehicle 150 having a first delivery compartment, said first delivery compartment containing said ordered item 151, and a second delivery compartment, said second delivery compartment containing a second item 152, said second item 152 being a single second item or a plurality of second items, each of said plurality of second items being identical, different, or a combination thereof, said second item 152 being determined by said central server 110 based on analysis of said central database 112 according to a second pre-defined algorithm; an on-board delivery load management system 153 associated with said delivery vehicle 150, said on-board delivery load management system 153 being remotely coupled with said delivery load management system 100 and administrated by said central server 110; an on-board database 154 associated with said delivery vehicle 150, said on-board database 154 containing information about real-time on-board load, real-time vacant load capacity, said first delivery route, and similar, said on-board database 154 being administrated by said on-board delivery load management system 153, said delivery load management system 100, said central server 110, or a combination thereof; an on-board input end 155 associated with said delivery vehicle 150, said on-board input end 155 being an independent on-board input end or a plurality of independent on-board input ends, an on-board administrator being capable of modifying information about said real-time on-board load, said real-time vacant load capacity, and said similar, upon completion of delivery of said ordered item 151, said on-board input end 155 being administrated by said on-board delivery load management system 153, said delivery load management system 100, said central server 110, or a combination thereof; an on-board display end 156 associated with said delivery vehicle 150, said on-board display end 156 being a single on-board display end or a plurality of on-board display ends, said on-board display end 156 capable of displaying information about said real-time on-board load, said real-time vacant load capacity, and said similar to said on-board administrator, said on-board display end 156 being administrated by said on-board delivery load management system 153, said delivery load management system 100, said central server 110, or a combination thereof; an on-board telecommunication apparatus 157 associated with said delivery vehicle 150, said on-board telecommunication apparatus 157 capable of synchronizing and updating information between said on-board database 154 and said central database 112 in real-time; and an on-board GPS device 158 associated with said delivery vehicle 150, said on-board GPS device 158 capable of providing real-time location information of said delivery vehicle 150 to said on-board database 154.

Said first preferred delivery route provides a most efficient route for said delivery vehicle 150 to pick up said ordered item 151 and said second item 152 from said central pick up location 140 and deliver said ordered item 151 to said delivery destination based on analysis of said central database 112 by said central server 110.

Said central server 110 predicts a receipt of a new order, from said individual user 130, within a per-defined period of time after said delivery vehicle 150 left said central pick up location 140 with said ordered item 151 and said second item 152, for said second item 152 with a second delivery destination 170, said second delivery destination 170 being within a pre-defined parameter from, en route to, or return from, said delivery destination 160 at a second delivery time window, said second delivery time window being close to or within said delivery time window, based on analysis of said central database 112 according to said second pre-defined algorithm.

Said central server 110 receives said new order within said pre-defined period of time, updates said central database 112, modifies said first preferred delivery route to a second preferred delivery route based on analysis of said central database 112, said on-board database 154, or a combination thereof, according to said first pre-defined algorithm.

Said first pre-defined algorithm can be improved and modified either manually by said central administrator or automatically by said central server 110 based on information associated with said on-board database 154, said central database 112, or a combination thereof.

Said second-predefined algorithm can be improved and modified either manually by said central administrator or automatically by said central server 110 based on information associated with said new order, said pre-defined period of time, said second delivery location 170, said second delivery time window, said on-board database 154, said central database 112, or a combination thereof.

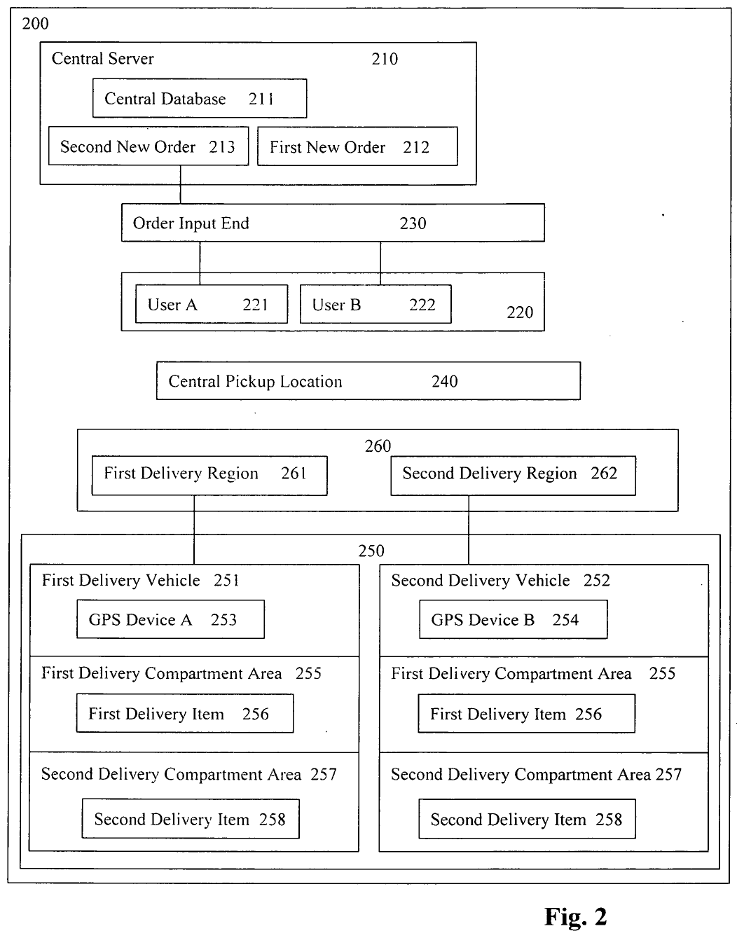

Referring now to FIG. 2, which is a structure demonstration drawing of a second preferred embodiment of a delivery load management system and method. Said delivery load management system 200 comprises a central server 210, said central server 210 being an independent server or a plurality of decentralized servers connected through internet; a group of registered users 220, said group of registered users 220 including at least User A 221 and User B 222, each individual registered user of said group of registered users 220 having access to an order input end 230 and capable of inputting order information, said order information containing identity information of each said individual registered user 220, an ordered item associated with each said individual registered user 220, said ordered item being a single ordered item or a plurality of ordered items, each of said plurality of ordered items being identical, different, or a combination thereof, a delivery destination and a delivery time window associated with said single ordered item or each of said plurality of ordered items, to said central server 210 through said order input end 230, said order input end 230 being remotely coupled with and administrated by said central server 210; a central pick up location 240, said central pick up location 240 being a single pick up location or a plurality of pick up locations, each of which having said ordered item, or a part thereof, said central pick up location 240 being administrated by said central server 210; a plurality of delivery vehicles 250, said plurality of delivery vehicles 250 including at least a first delivery vehicle 251 and a second delivery vehicle 252, each individual delivery vehicle of said plurality of delivery vehicles 250 having an on-board GPS device, said first delivery vehicle 251 having an on-board GPS device A 253 and said second delivery vehicle 252 having an on-board GPS device B 254, said on-board GPS device capable of providing real-time location information of said individual delivery vehicle to said central server 210, first delivery compartment area 255, said first delivery compartment area 255 containing a first delivery item 256, said first delivery item 256 being a single first delivery item or a plurality of first delivery items, each of said plurality of first delivery items being identical, different, or a combination thereof, said first delivery item 256 being said ordered item, and a second delivery compartment area 257, said second delivery compartment area 257 containing a second delivery item 258, said second delivery item 258 being a single second delivery item or a plurality of second delivery items, each of said plurality of second delivery items being identical, different, or a combination thereof, picked up from said central pick up location 240 determined by said central server 210 according to said pre-defined algorithm, said plurality of delivery vehicles 250 capable of providing real time delivery status information of said first delivery item 256 and said second delivery item 258 to, being remotely coupled with, and administrated by said central server 210; a central database 211, said central database 211 being a single central database or a plurality of decentralized database, said central database 211 containing said order information, information about said group of registered users 220, said central pick up location 240, said plurality of delivery vehicles 250, said first time, said second time, said pre-defined algorithm, other information related thereof, and being administrated by said central server 210; a plurality of delivery regions 260, said plurality of delivery regions 260 including at least a first delivery region 261 and a second delivery region 262, each individual delivery region of said plurality of delivery regions 260 including one or more of said delivery destination, at least one of said plurality of delivery regions 260 being assigned to at least one of said plurality of delivery vehicles 250, said first delivery region 261 being assigned to said first delivery vehicle 251 and said second delivery region 262 being assigned to said second delivery vehicle 252, said plurality of delivery regions 260 being defined by said central server 210 based on analysis of said central database 211 according to said pre-defined algorithm; and a plurality of delivery routes, said plurality of delivery routes containing at least a first delivery route, said first delivery route being assigned to said first delivery vehicle 251 for delivering said ordered item to said first delivery region 261, and a second delivery route, said second delivery route being assigned to said second delivery vehicle 252 for delivering said ordered item to said second delivery region 262, said plurality of delivery routes being most efficient routes combined for picking up said ordered item from said central pick up location 240 and delivering said ordered item to said destination associated therewith during said delivery time window associated therewith, each individual delivery route of said plurality of delivery routes being associated with one or more of said plurality of delivery regions 260 and assigned to one or more of said plurality of delivery vehicles 250, said plurality of delivery routes being defined by said central server 210 based on analysis of said central database 211 according to said pre-defined algorithm.

Said central server 210 is capable of predicting a first new order 212, from said group of registered users 220 within a first per-defined period of time after said first delivery vehicle 251 left said central pick up location 240 with said first delivery item 255 and said second delivery item 258, for said second delivery item 258 with a second delivery destination, said second delivery destination being within or close by said first delivery region 261, and a second delivery time window, said second delivery time window being close to or within said delivery time window, based on analysis of said central database 211 according to said pre-defined algorithm.

Said central server 210 receives a second new order 213, from said group of registered users 220 within a second per-defined period of time after said first delivery vehicle 251 left said central pick up location 240 with said first delivery item 256 and said second delivery item 258, for said second delivery item 258 with a third delivery destination, said third delivery destination being within or close by said first delivery region 261, and a third delivery time window, said third delivery time window being close to or within said delivery time window, updates said central database 211, and modifies said first delivery route to accomplish delivery of said first delivery item 256 to said first delivery destination within said delivery time window and said second delivery item 258 to said third delivery destination within said third delivery time window, based on analysis of said central database 211 according to said pre-defined algorithm.

Said central server 210 instructs said second delivery vehicle 252 to either meet said first delivery vehicle 251 to unload said second delivery item 258 to said first delivery vehicle 251, or return to said central pick up location 240 to unload said second delivery item 258, or to a new destination, upon completion of delivery of said first delivery item 256 on board said second delivery vehicle 252, based on analysis of said central database 211according to said pre-defined algorithm.

Said pre-defined algorithm can be improved and modified either manually by a central administrator of said central server 210 or automatically by said central server 210 based on analysis of said central database 211 according to said pre-defined algorithm.

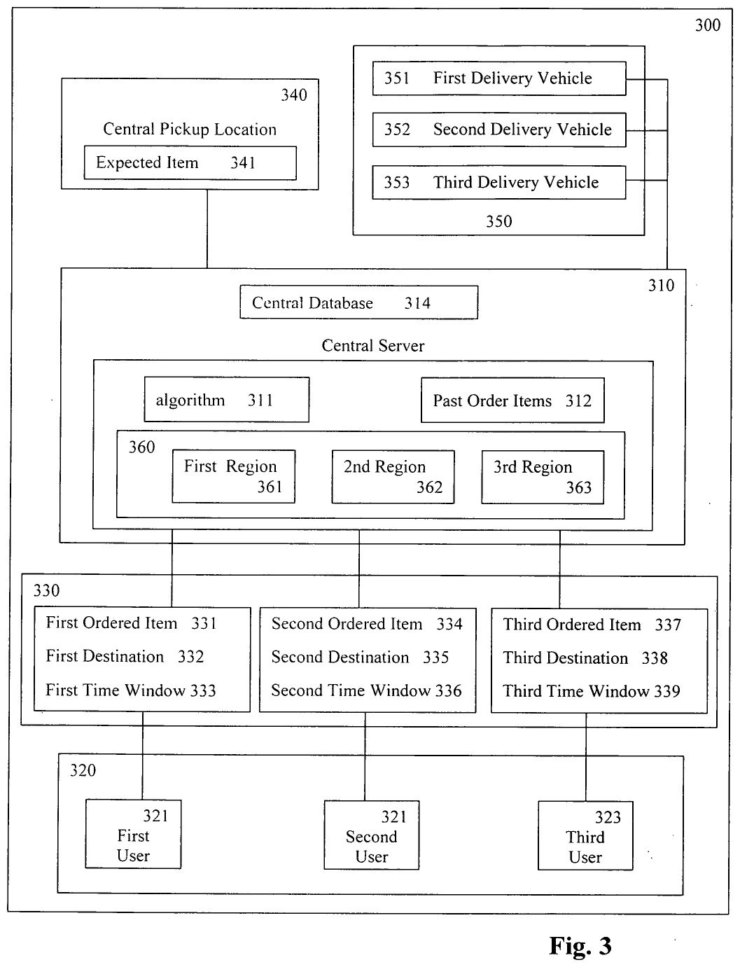

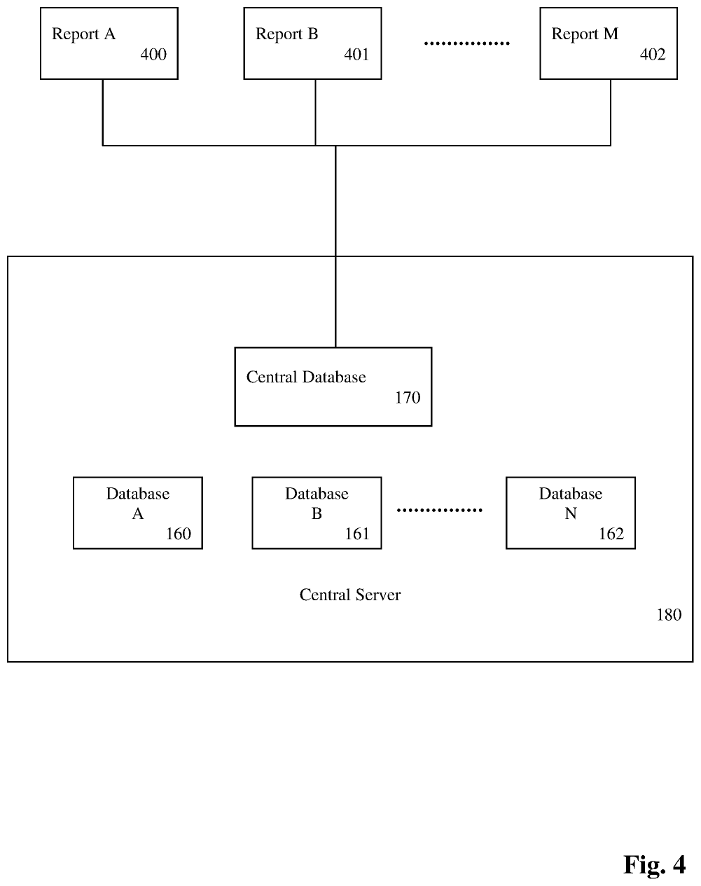

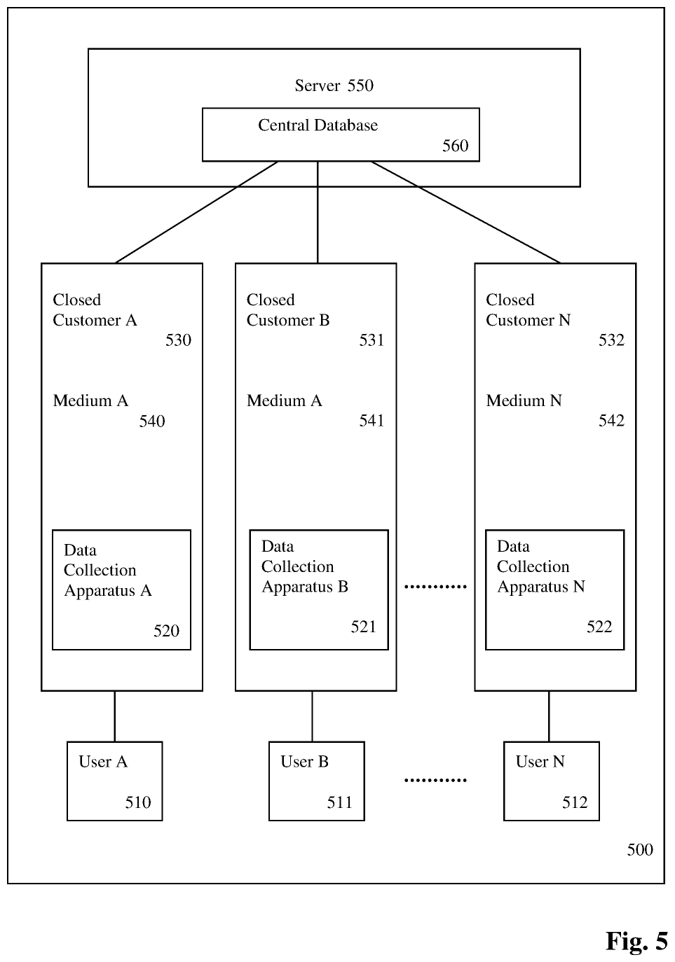

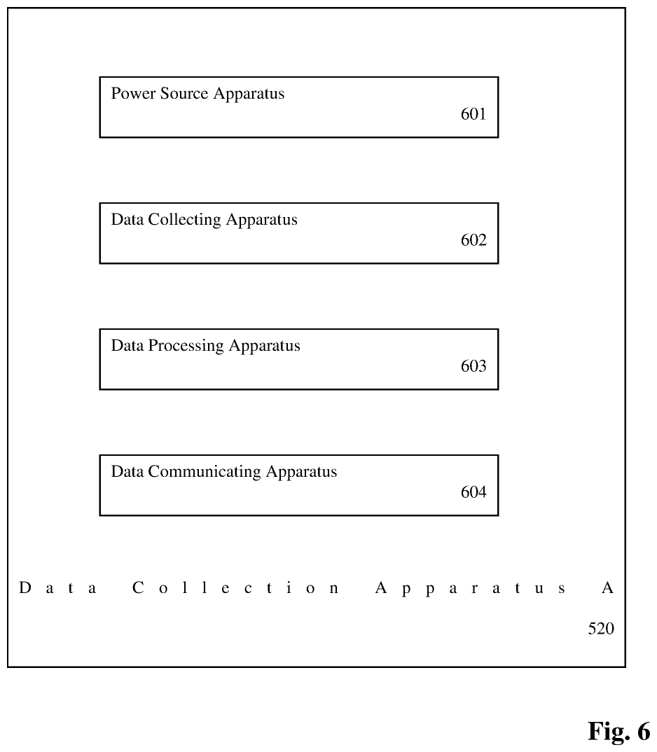

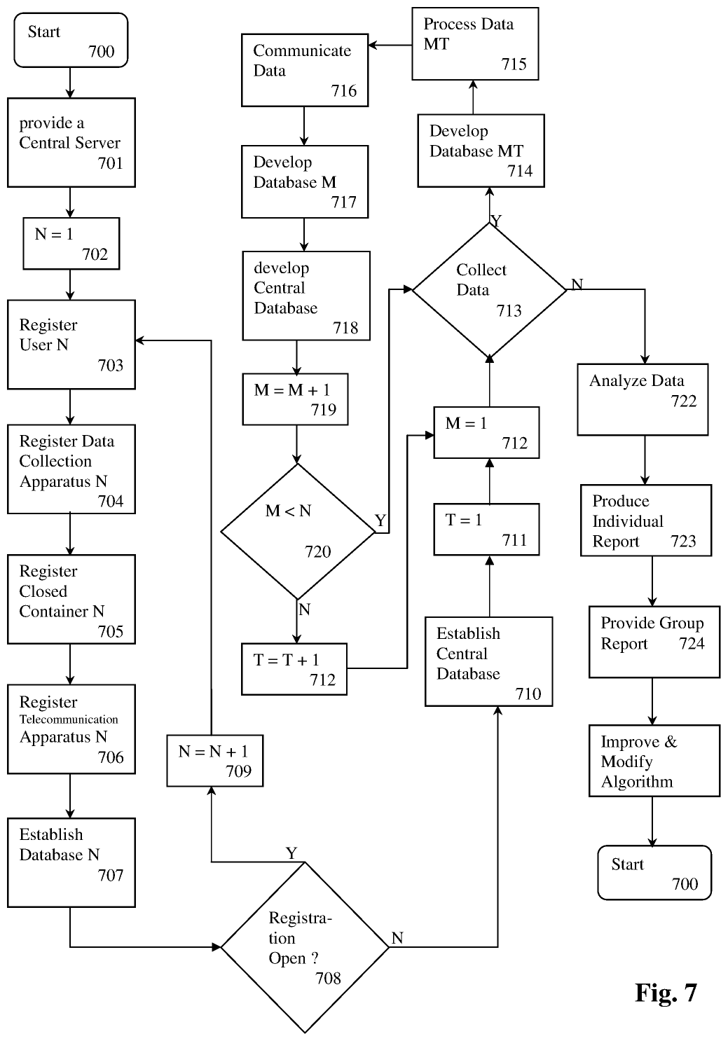

Referring now to FIG. 3, which is structure demonstration drawing of a third preferred embodiment of a delivery load management system and method. Said delivery load management system 300 comprises a central server 310, said central server 310 being an independent server or a plurality of decentralized servers connected through internet; an algorithm 311, said algorithm 311 being administrated by said central server 310; a group of registered users 320, said group of registered users 320 having at least a first user 321, a second user 322 and a third user 323, each individual registered user of said group of registered users 320 capable of placing order for delivery with said central server 310; a plurality of current ordered items 330, said plurality of current ordered items 330 ordered by said group of registered users 320, and containing at least a first ordered item 331, said first ordered item 331 being ordered by said first user 321 to be delivered to a first delivery destination 332 within a first delivery time window 333, said first ordered item 331 being a single first ordered item or a plurality of first ordered items, each of said plurality of first ordered items being identical, different, or a combination thereof, a second ordered item 334, said second ordered item 334 being ordered by said second user 322 to be delivered to a second delivery destination 335 within a second delivery time window 336, said second ordered item 334 being a single second ordered item or a plurality of second ordered items, each of said plurality of second ordered items being identical, different, or a combination thereof, and a third ordered item 337, said third ordered item 337 being ordered by said third user 323 to be delivered to a third delivery destination 338 within a third delivery time window 339, said third ordered item 337 being a single third ordered item or a plurality of third ordered items, each of said plurality of third ordered items being identical, different, or a combination thereof, each of said plurality of current ordered items being identical, different, or a combination thereof; a plurality of past ordered items 312, said plurality of past ordered items 312 having all past ordered items by said group of individual users 320, each of said past ordered items 312 being associated with one of said group of individual registered users 320, a past delivery destination and a past delivery time window; a central pick up location 340, said central pick up location 340 being a single pick up location or a plurality of pick up locations, said single pick up location or each of said plurality of pick up locations having at least said plurality of current ordered items 330, an expected item 341, said expected item 341 being a single expected item or a plurality of expected items, each of said plurality of expected items being identical, different, or a combination thereof, said expected item 341 being defined by said central server 310 based on analysis of said group of registered users 320, said plurality of current ordered items 330, said plurality of past ordered items 312, a part thereof, or a combination thereof, according to said algorithm, or a part thereof, or a combination thereof, said central pick up location 340 being administrated by said central server 310; a plurality of delivery vehicles 350, said plurality of delivery vehicles 350 being administrated by said central server 310, and including at least a first delivery vehicle 351, said first delivery vehicle 351 carrying said first ordered item 331 and said expected item 341, a second delivery vehicle 352, said second vehicle 352 carrying said second ordered item 334 and said expected item 341, and a third delivery vehicle 353, said third delivery vehicle 353 carrying said third ordered item 337 and said expected item 341, each individual delivery vehicle of said plurality of delivery vehicles 350 having an on-board GPS device, said on-board GPS device capable of providing real-time location information of said individual delivery vehicle to said central server 310; a plurality of delivery routes, said plurality of delivery routes containing at least a first delivery route, said first delivery route being assigned to said first delivery vehicle 351 for delivering said first ordered item 331 to said first delivery destination 332 within said first delivery time window 333, a second delivery route, said second delivery route being assigned to said second delivery vehicle 352 for delivering said second ordered item 334 to said second delivery destination 335 within said second delivery time window 336, and a third delivery route, said third delivery route being assigned to said third delivery vehicle 353 for delivering said third ordered item 337 to said third delivery destination 338 within said third delivery time window 339, said plurality of delivery routes being determined by said central server 310 based on analysis of said group of registered users 320, said plurality of current ordered items 330, said plurality of past ordered items 312, said plurality of delivery vehicles 350, said expected item 341, a part thereof, or a combination thereof, to be the most efficient routes combined for delivering of said plurality of ordered items 330 by said plurality of delivery vehicles 350, respectively, according to said algorithm 311; a plurality of delivery regions 360, said plurality of delivery regions 360 including at least a first delivery region 361, said first delivery region 361 containing said first delivery destination 332, a second delivery region 362, said second delivery region 362 containing said second delivery destination 335, and a third delivery region 363, said third delivery region 363 containing a third delivery destination 339, at least one of said plurality of delivery regions 330 being assigned to at least one of said plurality of delivery vehicles 350, said first delivery region 361 being assigned to said first delivery vehicle 351, said second delivery region 362 being assigned to said second delivery vehicle 352, and said third delivery region 363 being assigned to said third delivery vehicle 353, said plurality of delivery regions 360 being defined by said central server 310 based on analysis of said group of registered users 320, said plurality of current ordered items 330, said plurality of past ordered items 312, said plurality of delivery vehicles 350, said plurality of delivery routes, said expected item 341, a part thereof, or a combination thereof, according to said algorithm 311; a central database 314, said central database 314 being a single central database or a plurality of decentralized database, said central database 314 containing at least said algorithm 311, said group of registered users 320, said plurality of current ordered items 330, said plurality of past ordered items 312, said expected item 341, said central pick up location 340, said plurality of delivery vehicles 350, said plurality of delivery routes, and said plurality of delivery regions 360.

Said central server 310 is capable of predicting a first new order, from said group of registered user 320 within a first per-defined period of time after said first delivery vehicle 351 left said central pick up location 340 with said first ordered item 331 and said expected item 341, for said expected item 341 with a first expected delivery destination, said first expected delivery destination being within or close by said first delivery region 361, and a first expected delivery time window, said first expected delivery time window being close to or within said first delivery time window 333, based on analysis of said group of registered users 320, said plurality of current ordered items 330, said plurality of past ordered items 312, said central pick up location 340, said plurality of delivery vehicles 350, said plurality of delivery routes, said plurality of delivery regions 360, said central database 310, a part thereof, or a combination thereof, according to said pre-defined algorithm 311.

Said central server 310 receives a second new order, from said group of registered users 320 within a second per-defined period of time after said first delivery vehicle 351 left said central pick up location 340 with said first ordered item 331 and said expected item 341, for said expected item 341 with a second expected delivery destination, said second expected delivery destination being within or close by said first delivery region 361, and a second expected delivery time window, said second expected delivery time window being close to or within said first delivery time window 333, updates said central database 314, and modifies said first delivery route to accomplish delivery of said first ordered item 331 to said first delivery destination 332 within said first delivery time window 333 and said expected item 341 to said second expected delivery destination within said second expected delivery time window, based on analysis of said group of registered users 320, said plurality of current ordered items 330, said plurality of past ordered items 312, said central pick up location 340, said plurality of delivery vehicles 350, said plurality of delivery routes, said plurality of delivery regions 360, said real-time location information from said on-board GPS device, said central database 314, a part thereof, or a combination thereof, according to said algorithm 311.

Said central server 310 instructs said second delivery vehicle 352 to either meet said third delivery vehicle 353 to unload said second expected item 341 to said third delivery vehicle 353, or return to said central pick up location 340 to unload said expected item 341, or to a new destination, upon completion of delivery of said second delivery item 334 on board said second delivery vehicle 352, based on analysis of said group of registered users 320, said plurality of current ordered items 330, said plurality of past ordered items 312, said central pick up location 340, said plurality of delivery vehicles 350, said plurality of delivery routes, said plurality of delivery regions 360, said central database 314, a part thereof, or a combination thereof, according to said algorithm 311.

Said central server 310 determines volume and identity of said expected item 341 to be carried by each of said plurality of delivery vehicles 350, said expected item 341 to be carried by each of said plurality of delivery vehicles 350 being identical, different, or a combination thereof, based on analysis of said group of registered users 320, said plurality of current ordered items 330, said plurality of past ordered items 312, said central pick up location 340, said plurality of delivery vehicles 350, said plurality of delivery routes, said plurality of delivery regions 360, said central database 314, a part thereof, or a combination thereof, according to said algorithm 311.

Said algorithm 311 can be improved and modified either manually by a central administrator of said central server 310 or automatically by said central server 310 based on analysis of said group of registered users 320, said plurality of current ordered items 330, said plurality of past ordered items 312, said central pick up location 340, said plurality of delivery vehicles 350, said plurality of delivery routes, said plurality of delivery regions 360, said central database 314, a part thereof, or a combination thereof, according to said algorithm 311.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

It is to be understood that the invention is not limited in its embodiments disclosed in the preceding description or illustration in the drawings. The invention is capable of other embodiments and of being practiced and carried out in various ways. It is to be understood that the phraseology and terminology employed herein are for the purpose of descriptions and illustrations, and should not b regarded as limitations.

The above description will enable any person skilled in the art to make and use this invention. It also sets forth the best embodiments for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

I claim:

1. A delivery load management system capable of providing fast delivery to a plurality of delivery destinations, said delivery load management system comprising:
a central server, said central server being an independent server or a plurality of decentralized servers connected through internet;
an order input end, said order input end being an independent order input end or a plurality of decentralized order input ends, said order input end being remotely coupled with and administrated by said central server;
an individual user, said individual user being a single individual user or a group of individual users, each of whom being able to input order data through said order input end, said order data containing information about said individual user, an ordered item, said ordered item being a single item or a plurality of items, a delivery destination, said delivery destination being a single delivery destination or a plurality of delivery destination, associated with said single item or each of said plurality of items, a delivery time window associated with said single item or each of said plurality of items, and similar;
a central display end, said central display end being a single central display end or a plurality of central display ends, said central display end being capable of display said order data to a central administrator, said central administrator being a single central administrator or a group of central administrators;
a central database, said central database being a single central database or a plurality of central database, said central database containing said order data and being administrated by said central server;
a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
a central pick up location, said central pick up location being a single pick up location or a plurality of single pick up locations, each of which having said ordered item, or a part thereof, said central pick up location being administrated by said central server;
a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
an on-board delivery load management system associated with said delivery vehicle, said on-board delivery load management system being remotely coupled with said delivery load management system and administrated by said central server;
an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
an on-board telecommunication apparatus associated with said delivery vehicle, said on-board telecommunication apparatus capable of synchronizing and updating information between said on-board database and said central database in real-time; and
an on-board GPS device associated with said delivery vehicle, said on-board GPS device capable of providing real-time location information of said delivery vehicle to said on-board database.

2. The delivery load management system of claim 1, wherein said first preferred delivery route provides a most efficient route for said delivery vehicle to pick up said ordered item and said second item from said central pick up location and deliver said ordered item to said delivery destination based on analysis of said central database by said central server.

3. The delivery load management system of claim 2, wherein said central server predicts a receipt of a new order, from said individual user, within a per-defined period of time after said delivery vehicle left said central pick up location with said ordered item and said second item, for said second item with a second delivery destination, said second delivery destination being within a pre-defined parameter from, en route to, or return from, said delivery destination at a second delivery time window, said second delivery time window being close to or within said delivery time window, based on analysis of said central database according to said second pre-defined algorithm.

4. The delivery load management system of claim 3, wherein said central server receives said new order within said pre-defined period of time, updates said central database, modifies said first preferred delivery route to a second preferred delivery route based on analysis of said central database, said on-board database, or a combination thereof, according to said first pre-defined algorithm.

5. The delivery load management system of claim 4, wherein said first pre-defined algorithm can be improved and modified either manually by said central administrator or automatically by said central server based on information associated with said on-board database, said central database, or a combination thereof.

6. The delivery load management system of claim 5, wherein said second-predefined algorithm can be improved and modified either manually by said central administrator or automatically by said central server based on information associated with said new order, said pre-defined period of time, said second delivery location, said second delivery time window, said on-board database, said central database, or a combination thereof.

7. A delivery load management method capable of providing fast delivery to a plurality of delivery destinations, said delivery load management method comprising:
providing a central server, said central server being an independent server or a plurality of decentralized servers connected through internet;
providing an order input end, said order input end being an independent order input end or a plurality of decentralized order input ends, said order input end being remotely coupled with and administrated by said central server;
registering an individual user, said individual user being a single individual user or a group of individual users, each of whom being able to input order data through said order input end, said order data containing information about said individual user, ordered item, said ordered item being a single item or a plurality of items, a delivery destination, said delivery destination being a single delivery destination or a plurality of delivery destination, associated with said single item or each of said plurality of items, a delivery time window associated with said single item or each of said plurality of items, and similar;
providing a central display end, said central display end being a single central display end or a plurality of central display ends, said central display end being capable of display said order data to a central administrator, said central administrator being a single central administrator or a group of central administrators;
establishing a central database, said central database being a single central database or a plurality of central database, said central database containing said order data and being administrated by said central server;
providing a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
providing a central pick up location, said central pick up location being a single pick up location or a plurality of single pick up locations, each of which having said ordered item, or a part thereof, said central pick up location being administrated by said central server;
providing a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
providing an on-board delivery load management system associated with said delivery vehicle, said on-board delivery load management system being remotely coupled with said delivery load management system and administrated by said central server;
providing an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
providing an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
providing an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
providing an on-board telecommunication apparatus associated with said delivery vehicle, said on-board telecommunication apparatus capable of synchronizing and updating information between said on-board database and said central database in real-time; and
providing an on-board GPS device associated with said delivery vehicle, said on-board GPS device capable of providing real-time location information of said delivery vehicle to said on-board database.

8. The delivery load management method of claim 7, wherein said first preferred delivery route provides a most efficient route for said delivery vehicle to pick up said ordered item and said second item from said central pick up location and deliver said ordered item to said delivery destination based on analysis of said central database by said central server.

9. The delivery load management method of claim 8, wherein said central server predicts a receipt of a new order, from said individual user, within a per-defined period of time after said delivery vehicle left said central pick up location with said ordered item and said second item, for said second item with a second delivery destination, said second delivery destination being within a pre-defined parameter from, en route to, or return from, said delivery destination at a second delivery time window, said second delivery time window being close to or within said delivery time window, based on analysis of said central database according to said second pre-defined algorithm.

10. The delivery load management method of claim 9, wherein said central server receives said new order within said pre-defined period of time, updates said central database, modifies said first preferred delivery route to a second preferred delivery route based on analysis of said central database, said on-board database, or a combination thereof, according to said first pre-defined algorithm.

11. The delivery load management method of claim 10, wherein said first pre-defined algorithm can be improved and modified either manually by said central administrator or automatically by said central server based on information associated with said on-board database, said central database, or a combination thereof.

12. The delivery load management method of claim 11, wherein said second-predefined algorithm can be improved and modified either manually by said central administrator or automatically by said central server based on information associated with said new order, said pre-defined period of time, said second delivery location, said second delivery time window, said on-board database, said central database, or a combination thereof.

13. A delivery load management system capable of providing fast delivery to a plurality of delivery destinations, said delivery load management system comprising:
means and computer means for providing a central server, said central server being an independent server or a plurality of decentralized servers connected through internet;
means and computer means for providing an order input end, said order input end being an independent order input end or a plurality of decentralized order input ends, said order input end being remotely coupled with and administrated by said central server;
means and computer means for registering an individual user, said individual user being a single individual user or a group of individual users, each of whom being able to input order data through said order input end, said order data containing information about said individual user, ordered item, said ordered item being a single item or a plurality of items, a delivery destination, said delivery destination being a single delivery destination or a plurality of delivery destinations, associated with said single item or each of said plurality of items, a delivery time window associated with said single item or each of said plurality of items, and similar;
means and computer means for providing a central display end, said central display end being a single central display end or a plurality of central display ends, said central display end being capable of display said order data to a central administrator, said central administrator being a single central administrator or a group of central administrators;
means and computer means for establishing a central database, said central database being a single central database or a plurality of central database, said central database containing said order data and being administrated by said central server;
means and computer means for providing a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
means and computer means for providing a central pick up location, said central pick up location being a single pick up location or a plurality of single pick up locations, each of which having said ordered item, or a part thereof, said central pick up location being administrated by said central server;
means and computer means for providing a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
means and computer means for providing an on-board delivery load management system associated with said delivery vehicle, said on-board delivery load management system being remotely coupled with said delivery load management system and administrated by said central server;
means and computer means for providing an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
means and computer means for providing an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
means and computer means for providing an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
means and computer means for providing an on-board telecommunication apparatus associated with said delivery vehicle, said on-board telecommunication apparatus capable of synchronizing and updating information between said on-board database and said central database in real-time; and
means and computer means for providing an on-board GPS device associated with said delivery vehicle, said on-board GPS device capable of providing real-time location information of said delivery vehicle to said on-board database.

14. The delivery load management system of claim 13, wherein said first preferred delivery route provides a most efficient route for said delivery vehicle to pick up said ordered item and said second item from said central pick up location and deliver said ordered item to said delivery destination based on analysis of said central database by said central server.

15. The delivery load management system of claim 14, wherein said central server predicts a receipt of a new order, from said individual user, within a per-defined period of time after said delivery vehicle left said central pick up location with said ordered item and said second item, for said second item with a second delivery destination, said second delivery destination being within a pre-defined parameter from, en route to, or return from, said delivery destination at a second delivery time window, said second delivery time window being close to or within said delivery time window, based on analysis of said central database according to said second pre-defined algorithm.

16. The delivery load management system of claim 15, wherein said central server receives said new order within said pre-defined period of time, updates said central database, modifies said first preferred delivery route to a second preferred delivery route based on analysis of said central database, said on-board database, or a combination thereof, according to said first pre-defined algorithm.

17. The delivery load management system of claim 16, wherein said first pre-defined algorithm can be improved and modified either manually by said central administrator or automatically by said central server based on information associated with said on-board database, said central database, or a combination thereof.

18. The delivery load management system of claim 17, wherein said second-predefined algorithm can be improved and modified either manually by said central administrator or automatically by said central server based on information associated with said new order, said pre-defined period of time, said second delivery location, said second delivery time window, said on-board database, said central database, or a combination thereof.

19. A delivery load management system capable of providing fast delivery to a plurality of delivery destinations, said delivery load management system comprising:
a central server, said central server being an independent server or a plurality of decentralized servers connected through internet;
an order input end, said order input end being an independent order input end or a plurality of decentralized order input ends, said order input end being remotely coupled with and administrated by said central server;
an individual user, said individual user being a single individual user or a group of individual users, each of whom being able to input order data through said order input end, said order data containing information about said individual user, ordered item, said ordered item being a single item or a plurality of items, a delivery destination, said delivery destination being a single delivery destination or a plurality of delivery destinations, associated with said single item or each of said plurality of items, a delivery time window associated with said single item or each of said plurality of items, and similar;
a central display end, said central display end being a single central display end or a plurality of central display ends, said central display end being capable of display said order data to a central administrator, said central administrator being a single central administrator or a group of central administrators;
a central database, said central database being a single central database or a plurality of central database, said central database containing said order data and being administrated by said central server;
a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
a central pick up location, said central pick up location being a single pick up location or a plurality of single pick up locations, each of which having said ordered item, or a part thereof, said central pick up location being administrated by said central server;
a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
an on-board delivery load management system associated with said delivery vehicle, said on-board delivery load management system being remotely coupled with said delivery load management system and administrated by said central server;
an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
an on-board telecommunication apparatus associated with said delivery vehicle, said on-board telecommunication apparatus capable of synchronizing and updating information between said on-board database and said central database in real-time; and
an on-board GPS device associated with said delivery vehicle, said on-board GPS device capable of providing real-time location information of said delivery vehicle to said on-board database.

20. The delivery load management system of claim 19, wherein said first preferred delivery route provides a most efficient route for said delivery vehicle to pick up said ordered item and said second item from said central pick up location and deliver said ordered item to said delivery destination based on analysis of said central database by said central server.

21. The delivery load management system of claim 19, wherein said central server predicts a receipt of a first new order, from said individual user, within a first per-defined period of time after said delivery vehicle left said central pick up location with said ordered item and said second item, for said second item with a first new delivery destination, said first new delivery destination being within a first pre-defined parameter from, en route to, or return from, said delivery destination at a first new delivery time window, said first new delivery time window being close to or within said delivery time window, based on analysis of said central database according to said second pre-defined algorithm.

22. The delivery load management system of claim 19, wherein said central server receives a second new order, from said individual user, within a second pre-defined period of time after said delivery vehicle left said central pickup location with said ordered item and said second item, for said second item with a second new delivery destination, said second new delivery destination being within a second pre-defined parameter from, en route to, or return from, said delivery location at a second new delivery time window, said second new delivery time window being close to or within said deliver time window, within said second pre-defined period of time, updates said central database, modifies said first preferred delivery route to a second preferred delivery route based on analysis of said central database, said on-board database, or a combination thereof, according to said first pre-defined algorithm.

23. The delivery load management system of claim 19, wherein said first pre-defined algorithm and said second pre-defined algorithm can be improved and modified either manually by said central administrator or automatically by said central server based on information associated with said on-board database, said central database, or a combination thereof.

24. The delivery load management system of claim 19, wherein said individual user has a choice to either pick up said ordered item at said delivery destination or said central pick up location.

25. A delivery load management method capable of providing fast delivery to a plurality of delivery destinations, said delivery load management method comprising:
providing a central server, said central server being an independent server or a plurality of decentralized servers connected through internet;
providing an order input end, said order input end being an independent order input end or a plurality of decentralized order input ends, said order input end being remotely coupled with and administrated by said central server;
registering an individual user, said individual user being a single individual user or a group of individual users, each of whom being able to input order data through said order input end, said order data containing information about said individual user, ordered item, said ordered item being a single item or a plurality of items, a delivery destination, said delivery destination being a single delivery destination or a plurality of delivery destinations, associated with said single item or each of said plurality of items, a delivery time window associated with said single item or each of said plurality of items, and similar;
providing a central display end, said central display end being a single central display end or a plurality of central display ends, said central display end being capable of display said order data to a central administrator, said central administrator being a single central administrator or a group of central administrators;
establishing a central database, said central database being a single central database or a plurality of central database, said central database containing said order data and being administrated by said central server;
providing a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
providing a central pick up location, said central pick up location being a single pick up location or a plurality of single pick up locations, each of which having said ordered item, or a part thereof, said central pick up location being administrated by said central server;
providing a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
providing an on-board delivery load management system associated with said delivery vehicle, said on-board delivery load management system being remotely coupled with said delivery load management system and administrated by said central server;
establishing an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
providing an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
providing an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
providing an on-board telecommunication apparatus associated with said delivery vehicle, said on-board telecommunication apparatus capable of synchronizing and updating information between said on-board database and said central database in real-time; and
providing an on-board GPS device associated with said delivery vehicle, said on-board GPS device capable of providing real-time location information of said delivery vehicle to said on-board database.

26. The delivery load management method of claim 25, wherein said first preferred delivery route provides a most efficient route for said delivery vehicle to pick up said ordered item and said second item from said central pick up location and deliver said ordered item to said delivery destination based on analysis of said central database by said central server.

27. The delivery load management method of claim 25, wherein said central server predicts a receipt of a first new order, from said individual user, within a first per-defined period of time after said delivery vehicle left said central pick up location with said ordered item and said second item, for said second item with a first new delivery destination, said first new delivery destination being within a first pre-defined parameter from, en route to, or return from, said delivery destination at a first new delivery time window, said first new delivery time window being close to or within said delivery time window, based on analysis of said central database according to said second pre-defined algorithm.

28. The delivery load management method of claim 25, wherein said central server receives a second new order, from said individual user, within a second pre-defined period of time after said delivery vehicle left said central pickup location with said ordered item and said second item, for said second item with a second new delivery destination, said second new delivery destination being within a second pre-defined parameter from, en route to, or return from, said delivery location at a second new delivery time window, said second new delivery time window being close to or within said deliver time window, within said second pre-defined period of time, updates said central database, modifies said first preferred delivery route to a second preferred delivery route based on analysis of said central database, said on-board database, or a combination thereof, according to said first pre-defined algorithm.

29. The delivery load management method of claim 25, wherein said first pre-defined algorithm and said second pre-defined algorithm can be improved and modified either manually by said central administrator or automatically by said central server based on information associated with said on-board database, said central database, or a combination thereof.

30. The delivery load management method of claim 25, wherein said individual user has a choice to either pick up said ordered item at said delivery destination or said central pick up location.

31. A delivery load management system capable of providing fast delivery to a plurality of delivery destinations, said delivery load management method comprising:
means and computer means for providing a central server, said central server being an independent server or a plurality of decentralized servers connected through internet;
means and computer means providing an order input end, said order input end being an independent order input end or a plurality of decentralized order input ends, said order input end being remotely coupled with and administrated by said central server;
means and computer means registering an individual user, said individual user being a single individual user or a group of individual users, each of whom being able to input order data through said order input end, said order data containing information about said individual user, ordered item, said ordered item being a single item or a plurality of items, a delivery destination, said delivery destination being a single delivery destination or a plurality of delivery destinations, associated with said single item or each of said plurality of items, a delivery time window associated with said single item or each of said plurality of items, and similar;
means and computer means providing a central display end, said central display end being a single central display end or a plurality of central display ends, said central display end being capable of display said order data to a central administrator, said central administrator being a single central administrator or a group of central administrators;
means and computer means establishing a central database, said central database being a single central database or a plurality of central database, said central database containing said order data and being administrated by said central server;
means and computer means providing a delivery route administrator, said delivery route administrator being a single delivery route administrator or a plurality of delivery route administrators, said delivery route administrator capable of generating a first preferred delivery route for delivery of said ordered item based on analysis of said central database by said central server according to a first pre-defined algorithm;
means and computer means providing a central pick up location, said central pick up location being a single pick up location or a plurality of single pick up locations, each of which having said ordered item, or a part thereof, said central pick up location being administrated by said central server;
means and computer means providing a delivery vehicle, said delivery vehicle being a single delivery vehicle or a plurality of delivery vehicles, said delivery vehicle having a first delivery compartment, said first delivery compartment containing said ordered item, and a second delivery compartment, said second delivery compartment containing a second item, said second item being a single second item or a plurality of second items, each of said plurality of second items being identical, different, or a combination thereof, said second item being determined by said central server based on analysis of said central database according to a second pre-defined algorithm;
means and computer means providing an on-board delivery load management system associated with said delivery vehicle, said on-board delivery load management system being remotely coupled with said delivery load management system and administrated by said central server;
means and computer means establishing an on-board database associated with said delivery vehicle, said on-board database containing information about real-time on-board load, real-time vacant load capacity, said first delivery route, and similar, said on-board database being administrated by said on-board delivery load management system, said delivery load management system, said central server, or a combination thereof;
means and computer means providing an on-board input end associated with said delivery vehicle, said on-board input end being an independent on-board input end or a plurality of independent on-board input ends, an on-board administrator being capable of modifying information about said real-time on-board load, said real-time vacant load capacity, and said similar, upon completion of delivery of said ordered item, said on-board input end being administrated by said on-board delivery load management system, said delivery load management system, said central server, or a combination thereof;
means and computer means providing an on-board display end associated with said delivery vehicle, said on-board display end being a single on-board display end or a plurality of on-board display ends, said on-board display end capable of displaying information about said real-time on-board load, said real-time vacant load capacity, and said similar to said on-board administrator, said on-board display end being administrated by said on-board delivery load management system, said delivery load management system, said central server, or a combination thereof;
means and computer means providing an on-board telecommunication apparatus associated with said delivery vehicle, said on-board telecommunication apparatus capable of synchronizing and updating information between said on-board database and said central database in real-time; and
means and computer means providing an on-board GPS device associated with said delivery vehicle, said on-board GPS device capable of providing real-time location information of said delivery vehicle to said on-board database.

32. The delivery load management system of claim 31, wherein said first preferred delivery route provides a most efficient route for said delivery vehicle to pick up said ordered item and said second item from said central pick up location and deliver said ordered item to said delivery destination based on analysis of said central database by said central server.

33. The delivery load management system of claim 31, wherein said central server predicts a receipt of a first new order, from said individual user, within a first per-defined period of time after said delivery vehicle left said central pick up location with said ordered item and said second item, for said second item with a first new delivery destination, said first new delivery destination being within a first pre-defined parameter from, en route to, or return from, said delivery destination at a first new delivery time window, said first new delivery time window being close to or within said delivery time window, based on analysis of said central database according to said second pre-defined algorithm.

34. The delivery load management system of claim 31, wherein said central server receives a second new order, from said individual user, within a second pre-defined period of time after said delivery vehicle left said central pickup location with said ordered item and said second item, for said second item with a second new delivery destination, said second new delivery destination being within a second pre-defined parameter from, en route to, or return from, said delivery location at a second new delivery time window, said second new delivery time window being close to or within said deliver time window, within said second pre-defined period of time, updates said central database, modifies said first preferred delivery route to a second preferred delivery route based on analysis of said central database, said on-board database, or a combination thereof, according to said first pre-defined algorithm.

35. The delivery load management system of claim 31, wherein said first pre-defined algorithm and said second pre-defined algorithm can be improved and modified either manually by said central administrator or automatically by said central server based on information associated with said on-board database, said central database, or a combination thereof.

36. The delivery load management system of claim 31, wherein said individual user has a choice to either pick up said ordered item at said delivery destination or said central pick up location.

37. A delivery load management system capable of providing fast delivery to a plurality of delivery destinations, said delivery load management system comprising:
a central server, said central server being an independent server or a plurality of decentralized servers connected through internet;
a group of registered users, each individual registered user of said group of registered users having access to an order input end and capable of inputting order information, said order information containing identity information of each said individual registered user, an ordered item associated with each said individual registered user, said ordered item being a single ordered item or a plurality of ordered items, each of said plurality of ordered items being identical, different, or a combination thereof, a delivery destination and a delivery time window associated with said single ordered item or each of said plurality of ordered items, to said central server through said order input end, said order input end being remotely coupled with and administrated by said central server;
a central pick up location, said central pick up location being a single pick up location or a plurality of pick up locations, each of which having said ordered item, or a part thereof, said central pick up location being administrated by said central server;
a plurality of delivery vehicles, said plurality of delivery vehicles including at least a first delivery vehicle and a second delivery vehicle, each individual delivery vehicle of said plurality of delivery vehicles having an on-board GPS device, said on-board GPS device capable of providing real-time location information of said individual delivery vehicle to said central server, first delivery compartment area, said first delivery compartment area containing a first delivery item, said first delivery item being a single first delivery item or a plurality of first delivery items, each of said plurality of first delivery items being identical, different, or a combination thereof, said first delivery item being said ordered item, and a second delivery compartment area, said second delivery compartment area containing a second delivery item, said second delivery item being a single second delivery item or a plurality of second delivery items, each of said plurality of second delivery items being identical, different, or a combination thereof, picked up from said central pick up location determined by said central server according to said pre-defined algorithm, said plurality of delivery vehicles capable of providing real time delivery status information of said first delivery item and said second delivery item to, being remotely coupled with, and administrated by said central server;
a central database, said central database being a single central database or a plurality of decentralized database, said central database containing said order information, information about said group of registered users, said central pick up location, said plurality of delivery vehicles, said first time, said second time, said pre-defined algorithm, other information related thereof, and being administrated by said central server;
a plurality of delivery regions, said plurality of delivery regions including at least a first delivery region and a second delivery region, each individual delivery region of said plurality of delivery regions including one or more of said delivery destination, at least one of said plurality of delivery regions being assigned to at least one of said plurality of delivery vehicles, said first delivery region being assigned to said first delivery vehicle and said second delivery region being assigned to said second delivery vehicle, said plurality of delivery regions being defined by said central server based on analysis of said central database according to said pre-defined algorithm; and
a plurality of delivery routes, said plurality of delivery routes containing at least a first delivery route, said first delivery route being assigned to said first delivery vehicle for delivering said ordered item to said first delivery region, and a second delivery route, said second delivery route being assigned to said second delivery vehicle for delivering said ordered item to said second delivery region, said plurality of delivery routes being most efficient routes combined for picking up said ordered item from said central pick up location and delivering said ordered item to said destination associated therewith during said delivery time window associated therewith, each individual delivery route of said plurality of delivery routes being associated with one or more of said plurality of delivery regions and assigned to one or more of said plurality of delivery vehicles, said plurality of delivery routes being defined by said central server based on analysis of said central database according to said pre-defined algorithm.

38. The delivery load management system of claim 37, wherein said central server is capable of predicting a first new order, from said group of registered users within a first per-defined period of time after said first delivery vehicle left said central pick up location with said first delivery item and said second delivery item, for said second delivery item with a second delivery destination, said second delivery destination being within or close by said first delivery region, and a second delivery time window, said second delivery time window being close to or within said delivery time window, based on analysis of said central database according to said pre-defined algorithm.

39. The delivery load management system of claim 37, wherein said central server receives a second new order, from said group of registered users within a second per-defined period of time after said first delivery vehicle left said central pick up location with said first delivery item and said second delivery item, for said second delivery item with a third delivery destination, said third delivery destination being within or close by said first delivery region, and a third delivery time window, said third delivery time window being close to or within said delivery time window, updates said central database, and modifies said first delivery route to accomplish delivery of said first delivery item to said first delivery destination within said delivery time window and said second delivery item to said third delivery destination within said third delivery time window, based on analysis of said central database according to said pre-defined algorithm.

40. The delivery load management system of claim 37, wherein said central server instructs said second delivery vehicle to either meet said first delivery vehicle to unload said second delivery item to said first delivery vehicle, or return to said central pick up location to unload said second delivery item, or to a new destination, upon completion of delivery of said first delivery item on board said second delivery vehicle, based on analysis of said central database according to said pre-defined algorithm.

41. The delivery load management system of claim 37, wherein said pre-defined algorithm can be improved and modified either manually by a central administrator of said central server or automatically by said central server based on analysis of said central database according to said pre-defined algorithm.

42. The delivery load management system of claim 37, wherein said each individual registered user has a choice to either pick up said ordered item at said delivery destination or said central pick up location.

43. A delivery load management method capable of providing fast delivery to a plurality of delivery destinations, said delivery load management method comprising:
providing a central server, said central server being an independent server or a plurality of decentralized servers connected through internet;
registering a group of registered users, each individual registered user of said group of registered users having access to an order input end and capable of inputting order information, said order information containing identity information of each said individual registered user, an ordered item associated with each said individual registered user, said ordered item being a single ordered item or a plurality of ordered items, each of said plurality of ordered items being identical, different, or a combination thereof, a delivery destination and a delivery time window associated with said single ordered item or each of said plurality of ordered items, to said central server through said order input end, said order input end being remotely coupled with and administrated by said central server;
providing a central pick up location, said central pick up location being a single pick up location or a plurality of pick up locations, each of which having said ordered item, or a part thereof, said central pick up location being administrated by said central server;
providing a plurality of delivery vehicles, said plurality of delivery vehicles including at least a first delivery vehicle and a second delivery vehicle, each individual delivery vehicle of said plurality of delivery vehicles having an on-board GPS device, said on-board GPS device capable of providing real-time location information of said individual delivery vehicle to said central server, first delivery compartment area, said first delivery compartment area containing a first delivery item, said first delivery item being a single first delivery item or a plurality of first delivery items, each of said plurality of first delivery items being identical, different, or a combination thereof, said first delivery item being said ordered item, and a second delivery compartment area, said second delivery compartment area containing a second delivery item, said second delivery item being a single second delivery item or a plurality of second delivery items, each of said plurality of second delivery items being identical, different, or a combination thereof, picked up from said central pick up location determined by said central server according to said pre-defined algorithm, said plurality of delivery vehicles capable of providing real time delivery status information of said first delivery item and said second delivery item to, being remotely coupled with, and administrated by said central server;
establishing a central database, said central database being a single central database or a plurality of decentralized database, said central database containing said order information, information about said group of registered users, said central pick up location, said plurality of delivery vehicles, said first time, said second time, said pre-defined algorithm, other information related thereof, and being administrated by said central server;
defining a plurality of delivery regions, said plurality of delivery regions including at least a first delivery region and a second delivery region, each individual delivery region of said plurality of delivery regions including one or more of said delivery destination, at least one of said plurality of delivery regions being assigned to at least one of said plurality of delivery vehicles, said first delivery region being assigned to said first delivery vehicle and said second delivery region being assigned to said second delivery vehicle, said plurality of delivery regions being defined by said central server based on analysis of said central database according to said pre-defined algorithm; and
defining a plurality of delivery routes, said plurality of delivery routes containing at least a first delivery route, said first delivery route being assigned to said first delivery vehicle for delivering said ordered item to said first delivery region, and a second delivery route, said second delivery route being assigned to said second delivery vehicle for delivering said ordered item to said second delivery region, said plurality of delivery routes being most efficient routes combined for picking up said ordered item from said central pick up location and delivering said ordered item to said destination associated therewith during said delivery time window associated therewith, each individual delivery route of said plurality of delivery routes being associated with one or more of said plurality of delivery regions and assigned to one or more of said plurality of delivery vehicles, said plurality of delivery routes being defined by said central server based on analysis of said central database according to said pre-defined algorithm.

44. The delivery load management method of claim 43, wherein said central server is capable of predicting a first new order, from said group of registered users within a first per-defined period of time after said first delivery vehicle left said central pick up location with said first delivery item and said second delivery item, for said second delivery item with a second delivery destination, said second delivery destination being within or close by said first delivery region, and a second delivery time window, said second delivery time window being close to or within said delivery time window, based on analysis of said central database according to said pre-defined algorithm.

45. The delivery load management method of claim 43, wherein said central server receives a second new order, from said group of registered users within a second per-defined period of time after said first delivery vehicle left said central pick up location with said first delivery item and said second delivery item, for said second delivery item with a third delivery destination, said third delivery destination being within or close by said first delivery region, and a third delivery time window, said third delivery time window being close to or within said delivery time window, updates said central database, and modifies said first delivery route to accomplish delivery of said first delivery item to said first delivery destination within said delivery time window and said second delivery item to said third delivery destination within said third delivery time window, based on analysis of said central database according to said pre-defined algorithm.

46. The delivery load management method of claim 43, wherein said central server instructs said second delivery vehicle to either meet said first delivery vehicle to unload said second delivery item to said first delivery vehicle, or return to said central pick up location to unload said second delivery item, or to a new destination, upon completion of delivery of said first delivery item on board said second delivery vehicle, based on analysis of said central database according to said pre-defined algorithm.

47. The delivery load management method of claim 43, wherein said pre-defined algorithm can be improved and modified either manually by a central administrator of said central server or automatically by said central server based on analysis of said central database according to said pre-defined algorithm.

48. The delivery load management method of claim 43, wherein said each individual registered user has a choice to either pick up said ordered item at said delivery destination or said central pick up location.

49. A delivery load management system capable of providing fast delivery to a plurality of delivery destinations, said delivery load management system comprising:
means and computer means for providing a central server, said central server being an independent server or a plurality of decentralized servers connected through internet;
means and computer means for registering a group of registered users, each individual registered user of said group of registered users having access to an order input end and capable of inputting order information, said order information containing identity information of each said individual registered user, an ordered item associated with each said individual registered user, said ordered item being a single ordered item or a plurality of ordered items, each of said plurality of ordered items being identical, different, or a combination thereof, a delivery destination and a delivery time window associated with said single ordered item or each of said plurality of ordered items, to said central server through said order input end, said order input end being remotely coupled with and administrated by said central server;
means and computer means for providing a central pick up location, said central pick up location being a single pick up location or a plurality of pick up locations, each of which having said ordered item, or a part thereof, said central pick up location being administrated by said central server;
means and computer means for providing a plurality of delivery vehicles, said plurality of delivery vehicles including at least a first delivery vehicle and a second delivery vehicle, each individual delivery vehicle of said plurality of delivery vehicles having an on-board GPS device, said on-board GPS device capable of providing real-time location information of said individual delivery vehicle to said central server, first delivery compartment area, said first delivery compartment area containing a first delivery item, said first delivery item being a single first delivery item or a plurality of first delivery items, each of said plurality of first delivery items being identical, different, or a combination thereof, said first delivery item being said ordered item, and a second delivery compartment area, said second delivery compartment area containing a second delivery item, said second delivery item being a single second delivery item or a plurality of second delivery items, each of said plurality of second delivery items being identical, different, or a combination thereof, picked up from said central pick up location determined by said central server according to said pre-defined algorithm, said plurality of delivery vehicles capable of providing real time delivery status information of said first delivery item and said second delivery item to, being remotely coupled with, and administrated by said central server;
means and computer means for establishing a central database, said central database being a single central database or a plurality of decentralized database, said central database containing said order information, information about said group of registered users, said central pick up location, said plurality of delivery vehicles, said first time, said second time, said pre-defined algorithm, other information related thereof, and being administrated by said central server;
means and computer means for defining a plurality of delivery regions, said plurality of delivery regions including at least a first delivery region and a second delivery region, each individual delivery region of said plurality of delivery regions including one or more of said delivery destination, at least one of said plurality of delivery regions being assigned to at least one of said plurality of delivery vehicles, said first delivery region being assigned to said first delivery vehicle and said second delivery region being assigned to said second delivery vehicle, said plurality of delivery regions being defined by said central server based on analysis of said central database according to said pre-defined algorithm; and
means and computer means for defining a plurality of delivery routes, said plurality of delivery routes containing at least a first delivery route, said first delivery route being assigned to said first delivery vehicle for delivering said ordered item to said first delivery region, and a second delivery route, said second delivery route being assigned to said second delivery vehicle for delivering said ordered item to said second delivery region, said plurality of delivery routes being most efficient routes combined for picking up said ordered item from said central pick up location and delivering said ordered item to said destination associated therewith during said delivery time window associated therewith, each individual delivery route of said plurality of delivery routes being associated with one or more of said plurality of delivery regions and assigned to one or more of said plurality of delivery vehicles, said plurality of delivery routes being defined by said central server based on analysis of said central database according to said pre-defined algorithm.

50. The delivery load management system of claim 49, wherein said central server is capable of predicting a first new order, from said group of registered users within a first per-defined period of time after said first delivery vehicle left said central pick up location with said first delivery item and said second delivery item, for said second delivery item with a second delivery destination, said second delivery destination being within or close by said first delivery region, and a second delivery time window, said second delivery time window being close to or within said delivery time window, based on analysis of said central database according to said pre-defined algorithm.

51. The delivery load management system of claim 49, wherein said central server receives a second new order, from said group of registered users within a second per-defined period of time after said first delivery vehicle left said central pick up location with said first delivery item and said second delivery item, for said second delivery item with a third delivery destination, said third delivery destination being within or close by said first delivery region, and a third delivery time window, said third delivery time window being close to or within said delivery time window, updates said central database, and modifies said first delivery route to accomplish delivery of said first delivery item to said first delivery destination within said delivery time window and said second delivery item to said third delivery destination within said third delivery time window, based on analysis of said central database according to said pre-defined algorithm.

52. The delivery load management system of claim 49, wherein said central server instructs said second delivery vehicle to either meet said first delivery vehicle to unload said second delivery item to said first delivery vehicle, or return to said central pick up location to unload said second delivery item, or to a new destination, upon completion of delivery of said first delivery item on board said second delivery vehicle, based on analysis of said central database according to said pre-defined algorithm.

53. The delivery load management system of claim 49, wherein said pre-defined algorithm can be improved and modified either manually by a central administrator of said central server or automatically by said central server based on analysis of said central database according to said pre-defined algorithm.

54. The delivery load management system of claim 49, wherein said each individual registered user has a choice to either pick up said ordered item at said delivery destination or said central pick up location.

55. A delivery load management method capable of providing fast delivery to a plurality of delivery destinations, said delivery load management method comprising:
providing a central server;
establishing a central database, said central database being administrated by said central server;
registering a plurality of users to said central server, each user of said plurality of users capable of placing orders for a plurality of delivery items, each of said plurality of delivery items being associated with a delivery location and a delivery time window, said plurality of delivery items including at least a first delivery item, said first delivery item being associated with a first delivery location and a first delivery time window, said first delivery item being a single first delivery item or a plurality of first delivery items, each of which being identical, different, or a combination thereof, and a second delivery item, said second delivery item being associated with a second delivery location and a second delivery time window, said second delivery item being a single second delivery item or a plurality of second delivery items, each of which being identical, different, or a combination thereof;
receiving said orders by said central server, said central server modifying said central database based on information related to said orders according to an algorithm;
registering a central pick up location to said central server, said central pick up location being a single central pick up location or a plurality of central pick up locations, said central pick up location having said plurality of delivery items or a part thereof and a plurality of expected delivery items, or a part thereof, said plurality of expected delivery items including at least a first expected delivery item, said first expected delivery item being associated with a first expected delivery location, said first expected delivery location being within proximity of, en route to, or return from said first delivery location, and a first expected delivery time window, said first expected delivery time window being within or close to said first delivery time window, and a second expected delivery item, said second expected delivery item being associated with a second expected delivery location, said second expected delivery location being within proximity of, en route to, or return from said second delivery location, and a second expected delivery time window, said second expected delivery time window being within or close to said second delivery time window;
registering a plurality of delivery vehicles to said central server, said plurality of delivery vehicles including at least a first delivery vehicle and a second delivery vehicle, said plurality of delivery vehicles being remotely coupled with and administrated by said central server;
picking up said at least one of said plurality of delivery items and at least one of said plurality of expected delivery items by at least one of said plurality of delivery vehicles determined and administrated by said central server, said first delivery vehicle picking up said first delivery item and said first expected delivery item, said second delivery vehicle picking up said second delivery item and said second expected delivery item, from said central pick up location;
delivering said at least one of said plurality of delivery items by at least one of said plurality of delivery vehicles to said delivery location within said delivery time window, said first delivery vehicle delivering said first delivery item to said first delivery location, said second delivery vehicle delivering said second delivery item to said second delivery location;
receiving new orders, said new orders including at least said first expected delivery item with said first expected delivery location within said first expected delivery time window, from at least one of said plurality of users by said central server, said central server modifying said central database based on information related to said new orders according to said algorithm; and
delivering said first expected delivery item to said first expected delivery location within said first expected delivery time window.

56. The delivery load management method of claim 55, wherein said first delivery item and said second delivery item are identical.

57. The delivery load management method of claim 55, wherein said orders and said new orders are identical.

58. The delivery load management method of claim 55, wherein said plurality of delivery items or a part thereof and said plurality of expected delivery items or a part thereof are identical.

59. The delivery load management method of claim 55, wherein said first expected delivery item and said second expected delivery item are identical.

60. The delivery load management method of claim 55, wherein said central server assigns at least one of said plurality of delivery items and at least one of said plurality of expected delivery items to at least one of said plurality of delivery vehicles based on analysis of said central database according to said algorithm.

61. The delivery load management method of claim 55, wherein said central server assigns said first delivery item and said first expected delivery item to said first deliver vehicle, and said second delivery item and said second expected delivery item to said second delivery vehicle based on analysis of said central database according to said algorithm.

62. The delivery load management method of claim 55, wherein said central server determines whether to request said second delivery vehicle to pass on said second expected delivery item to said first delivery vehicle upon completion of delivery of said second delivery item by said second delivery vehicle based on analysis of said central database according to said algorithm.

63. The delivery load management method of claim 55, wherein said central server assigns at least one of said plurality of delivery items and at least one of said plurality of expected delivery items to at least one of said plurality of delivery vehicles based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

64. The delivery load management method of claim 55, wherein said central server assigns said first delivery item and said first expected delivery item to said first deliver vehicle, and said second delivery item and said second expected delivery item to said second delivery vehicle based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

65. The delivery load management method of claim 55, wherein said central server determines whether to request said second delivery vehicle to pass on said second expected delivery item to said first delivery vehicle upon completion of delivery of said second delivery item by said second delivery vehicle based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

66. The delivery load management method of claim 55, wherein said central server modifies said algorithm based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof.

67. The delivery load management method of claim 55, wherein said each user has a choice to either pick up each of said plurality of delivery items at said delivery location or said central pick up location.

68. A delivery load management system capable of providing fast delivery to a plurality of delivery destinations, said delivery load management system comprising:
means and computer means for providing a central server;
means and computer means for establishing a central database, said central database being administrated by said central server;
means and computer means for registering a plurality of users to said central server, each user of said plurality of users capable of placing orders for a plurality of delivery items, each of said plurality of delivery items being associated with a delivery location and a delivery time window, said plurality of delivery items including at least a first delivery item, said first delivery item being associated with a first delivery location and a first delivery time window, said first delivery item being a single first delivery item or a plurality of first delivery items, each of which being identical, different, or a combination thereof, and a second delivery item, said second delivery item being associated with a second delivery location and a second delivery time window, said second delivery item being a single second delivery item or a plurality of second delivery items, each of which being identical, different, or a combination thereof;
means and computer means for receiving said orders by said central server, said central server modifying said central database based on information related to said orders according to an algorithm;
means and computer means for registering a central pick up location to said central server, said central pick up location being a single central pick up location or a plurality of central pick up locations, said central pick up location having said plurality of delivery items or a part thereof and a plurality of expected delivery items, or a part thereof, said plurality of expected delivery items including at least a first expected delivery item, said first expected delivery item being associated with a first expected delivery location, said first expected delivery location being within proximity of, en route to, or return from said first delivery location, and a first expected delivery time window, said first expected delivery time window being within or close to said first delivery time window, and a second expected delivery item, said second expected delivery item being associated with a second expected delivery location, said second expected delivery location being within proximity of, en route to, or return from said second delivery location, and a second expected delivery time window, said second expected delivery time window being within or close to said second delivery time window;
means and computer means for registering a plurality of delivery vehicles to said central server, said plurality of delivery vehicles including at least a first delivery vehicle and a second delivery vehicle, said plurality of delivery vehicles being remotely coupled with and administrated by said central server;
means and computer means for picking up said at least one of said plurality of delivery items and at least one of said plurality of expected delivery items by at least one of said plurality of delivery vehicles determined and administrated by said central server, said first delivery vehicle picking up said first delivery item and said first expected delivery item, said second delivery vehicle picking up said second delivery item and said second expected delivery item, from said central pick up location;
means and computer means for delivering said at least one of said plurality of delivery items by at least one of said plurality of delivery vehicles to said delivery location within said delivery time window, said first delivery vehicle delivering said first delivery item to said first delivery location, said second delivery vehicle delivering said second delivery item to said second delivery location;
means and computer means for receiving new orders, said new orders including at least said first expected delivery item with said first expected delivery location within said first expected delivery time window, from at least one of said plurality of users by said central server, said central server modifying said central database based on information related to said new orders according to said algorithm; and
means and computer means for delivering said first expected delivery item to said first expected delivery location within said first expected delivery time window.

69. The delivery load management system of claim 68, wherein said first delivery item and said second delivery item are identical.

70. The delivery load management system of claim 68, wherein said orders and said new orders are identical.

71. The delivery load management system of claim 68, wherein said plurality of delivery items or a part thereof and said plurality of expected delivery items or a part thereof are identical.

72. The delivery load management system of claim 68, wherein said first expected delivery item and said second expected delivery item are identical.

73. The delivery load management system of claim 68, wherein said central server assigns at least one of said plurality of delivery items and at least one of said plurality of expected delivery items to at least one of said plurality of delivery vehicles based on analysis of said central database according to said algorithm.

74. The delivery load management system of claim 68, wherein said central server assigns said first delivery item and said first expected delivery item to said first deliver vehicle, and said second delivery item and said second expected delivery item to said second delivery vehicle based on analysis of said central database according to said algorithm.

75. The delivery load management system of claim 68, wherein said central server determines whether to request said second delivery vehicle to pass on said second expected delivery item to said first delivery vehicle upon completion of delivery of said second delivery item by said second delivery vehicle based on analysis of said central database according to said algorithm.

76. The delivery load management system of claim 68, wherein said central server assigns at least one of said plurality of delivery items and at least one of said plurality of expected delivery items to at least one of said plurality of delivery vehicles based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

77. The delivery load management system of claim 68, wherein said central server assigns said first delivery item and said first expected delivery item to said first deliver vehicle, and said second delivery item and said second expected delivery item to said second delivery vehicle based on analysis of said orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

78. The delivery load management system of claim 68, wherein said central server determines whether to request said second delivery vehicle to pass on said second expected delivery item to said first delivery vehicle upon completion of delivery of said second delivery item by said second delivery vehicle based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof, according to said algorithm.

79. The delivery load management system of claim 68, wherein said central server modifies said algorithm based on analysis of said orders, said new orders, said pick up location, said plurality of delivery items or a part thereof, said delivery location said delivery time window, said plurality of expected delivery items or a part thereof, said expected delivery location, said expected delivery time window, said plurality of delivery vehicles, said central database, or a combination thereof.

80. The delivery load management system of claim 68, wherein said each user has a choice to either pick up each of said plurality of delivery items at said delivery location or said central pick up location.

81. A delivery load management system capable of providing fast delivery to a plurality of delivery destinations, said delivery load management system comprising:
a central server, said central server being an independent server or a plurality of decentralized servers connected through internet;
an algorithm, said algorithm being administrated by said central server;
a group of registered users, said group of registered users having at least a first user, a second user and a third user, each individual registered user of said group of registered users capable of placing order for delivery with said central server;
a plurality of current ordered items, said plurality of current ordered items ordered by said group of registered users, and containing at least a first ordered item, said first ordered item being ordered by said first user to be delivered to a first delivery destination within a first delivery time window, said first ordered item being a single first ordered item or a plurality of first ordered items, each of said plurality of first ordered items being identical, different, or a combination thereof, a second ordered item, said second ordered item being ordered by said second user to be delivered to a second delivery destination within a second delivery time window, said second ordered item being a single second ordered item or a plurality of second ordered items, each of said plurality of second ordered items being identical, different, or a combination thereof, and a third ordered item, said third ordered item being ordered by said third user to be delivered to a third delivery destination within a third delivery time window, said third ordered item being a single third ordered item or a plurality of third ordered items, each of said plurality of third ordered items being identical, different, or a combination thereof, each of said plurality of current ordered items being identical, different, or a combination thereof;
a plurality of past ordered items, said plurality of past ordered items having all past ordered items by said group of individual users, each of said past ordered items being associated with one of said group of individual registered users, a past delivery destination and a past delivery time window;
a central pick up location, said central pick up location being a single pick up location or a plurality of pick up locations, said single pick up location or each of said plurality of pick up locations having at least said plurality of current ordered items, an expected item, said expected item being a single expected item or a plurality of expected items, each of said plurality of expected items being identical, different, or a combination thereof, said expected item being defined by said central server based on analysis of said group of registered users, said plurality of current ordered items, said plurality of past ordered items, a part thereof, or a combination thereof, according to said algorithm, or a part thereof, or a combination thereof, said central pick up location being administrated by said central server;
a plurality of delivery vehicles, said plurality of delivery vehicles being administrated by said central server, and including at least a first delivery vehicle, said first delivery vehicle carrying said first ordered item and said expected item, a second delivery vehicle, said second vehicle carrying said second ordered item and said expected item, and a third delivery vehicle, said third delivery vehicle carrying said third ordered item and said expected item, each individual delivery vehicle of said plurality of delivery vehicles having an on-board GPS device, said on-board GPS device capable of providing real-time location information of said individual delivery vehicle to said central server;
a plurality of delivery routes, said plurality of delivery routes containing at least a first delivery route, said first delivery route being assigned to said first delivery vehicle for delivering said first ordered item to said first delivery destination within said first delivery time window, a second delivery route, said second delivery route being assigned to said second delivery vehicle for delivering said second ordered item to said second delivery destination within said second delivery time window, and a third delivery route, said third delivery route being assigned to said third delivery vehicle for delivering said third ordered item to said third delivery destination within said third delivery time window, said plurality of delivery routes being determined by said central server based on analysis of said group of registered users, said plurality of current ordered items, said plurality of past ordered items, said plurality of delivery vehicles, said expected item, a part thereof, or a combination thereof, to be the most efficient routes combined for delivering of said plurality of ordered items by said plurality of delivery vehicles, respectively, according to said algorithm;
a plurality of delivery regions, said plurality of delivery regions including at least a first delivery region, said first delivery region containing said first delivery destination, a second delivery region, said second delivery region containing said second delivery destination, and a third delivery region, said third delivery region containing a third delivery destination, at least one of said plurality of delivery regions being assigned to at least one of said plurality of delivery vehicles, said first delivery region being assigned to said first delivery vehicle, said second delivery region being assigned to said second delivery vehicle, and said third delivery region being assigned to said third delivery vehicle, said plurality of delivery regions being defined by said central server based on analysis of said group of registered users, said plurality of current ordered items, said plurality of past ordered items, said plurality of delivery vehicles, said plurality of delivery routes, said expected item, a part thereof, or a combination thereof, according to said algorithm;
a central database, said central database being a single central database or a plurality of decentralized database, said central database containing at least said algorithm, said group of registered users, said plurality of current ordered items, said plurality of past ordered items, said expected item, said central pick up location, said plurality of delivery vehicles, said plurality of delivery routes, and said plurality of delivery regions.

82. The delivery load management system of claim 81, wherein said central server is capable of predicting a first new order, from said group of registered users within a first per-defined period of time after said first delivery vehicle left said central pick up location with said first ordered item and said expected item, for said expected item with a first expected delivery destination, said first expected delivery destination being within or close by said first delivery region, and a first expected delivery time window, said first expected delivery time window being close to or within said first delivery time window, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

83. The delivery load management system of claim 81, wherein said central server receives a second new order, from said group of registered users within a second per-defined period of time after said first delivery vehicle left said central pick up location with said first ordered item and said expected item, for said expected item with a second expected delivery destination, said second expected delivery destination being within or close by said first delivery region, and a second expected delivery time window, said second expected delivery time window being close to or within said first delivery time window, updates said central database, and modifies said first delivery route to accomplish delivery of said first ordered item to said first delivery destination within said first delivery time window and said expected item to said second expected delivery destination within said second expected delivery time window, based on analysis of said group of registered users, said plurality of current ordered items, said plurality of past ordered items, said central pick up location, said plurality of delivery vehicles, said plurality of delivery routes, said plurality of delivery regions, said real-time location information from said on-board GPS device, said central database, a part thereof, or a combination thereof, according to said algorithm.

84. The delivery load management system of claim 81, wherein said central server instructs said second delivery vehicle to either meet said third delivery vehicle to unload said second expected item to said third delivery vehicle, or return to said central pick up location to unload said expected item, or to a new destination, upon completion of delivery of said second ordered item on board said second delivery vehicle, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

85. The delivery load management system of claim 81, wherein said central server determines volume and identity of said expected item to be carried by each of said plurality of delivery vehicles, said expected item to be carried by each of said plurality of delivery vehicles being identical, different, or a combination thereof, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

86. The delivery load management system of claim 81, wherein said algorithm can be improved and modified either manually by a central administrator of said central server or automatically by said central server based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

87. A delivery load management method capable of providing fast delivery to a plurality of delivery destinations, said delivery load management system comprising:
providing a central server, said central server being an independent server or a plurality of decentralized servers connected through internet;
developing an algorithm, said algorithm being administrated by said central server;
registering a group of registered users, said group of registered users having at least a first user, a second user and a third user, each individual registered user of said group of registered users capable of placing order for delivery with said central server;
receiving a plurality of current ordered items, said plurality of current ordered items ordered by said group of registered users, and containing at least a first ordered item, said first ordered item being ordered by said first user to be delivered to a first delivery destination within a first delivery time window, said first ordered item being a single first ordered item or a plurality of first ordered items, each of said plurality of first ordered items being identical, different, or a combination thereof, a second ordered item, said second ordered item being ordered by said second user to be delivered to a second delivery destination within a second delivery time window, said second ordered item being a single second ordered item or a plurality of second ordered items, each of said plurality of second ordered items being identical, different, or a combination thereof, and a third ordered item, said third ordered item being ordered by said third user to be delivered to a third delivery destination within a third delivery time window, said third ordered item being a single third ordered item or a plurality of third ordered items, each of said plurality of third ordered items being identical, different, or a combination thereof, each of said plurality of current ordered items being identical, different, or a combination thereof;
providing a plurality of past ordered items, said plurality of past ordered items having all past ordered items by said group of individual users, each of said past ordered items being associated with one of said group of individual registered users, a past delivery destination and a past delivery time window;
providing a central pick up location, said central pick up location being a single pick up location or a plurality of pick up locations, said single pick up location or each of said plurality of pick up locations having at least said plurality of current ordered items, an expected item, said expected item being a single expected item or a plurality of expected items, each of said plurality of expected items being identical, different, or a combination thereof, said expected item being defined by said central server based on analysis of said group of registered users, said plurality of current ordered items, said plurality of past ordered items, a part thereof, or a combination thereof, according to said algorithm, or a part thereof, or a combination thereof, said central pick up location being administrated by said central server;
providing a plurality of delivery vehicles, said plurality of delivery vehicles being administrated by said central server, and including at least a first delivery vehicle, said first delivery vehicle carrying said first ordered item and said expected item, a second delivery vehicle, said second vehicle carrying said second ordered item and said expected item, and a third delivery vehicle, said third delivery vehicle carrying said third ordered item and said expected item, each individual delivery vehicle of said plurality of delivery vehicles having an on-board GPS device, said on-board GPS device capable of providing real-time location information of said individual delivery vehicle to said central server;
developing a plurality of delivery routes, said plurality of delivery routes containing at least a first delivery route, said first delivery route being assigned to said first delivery vehicle for delivering said first ordered item to said first delivery destination within said first delivery time window, a second delivery route, said second delivery route being assigned to said second delivery vehicle for delivering said second ordered item to said second delivery destination within said second delivery time window, and a third delivery route, said third delivery route being assigned to said third delivery vehicle for delivering said third ordered item to said third delivery destination within said third delivery time window, said plurality of delivery routes being determined by said central server based on analysis of said group of registered users, said plurality of current ordered items, said plurality of past ordered items, said plurality of delivery vehicles, said expected item, a part thereof, or a combination thereof, to be the most efficient routes combined for delivering of said plurality of ordered items by said plurality of delivery vehicles, respectively, according to said algorithm;
defining a plurality of delivery regions, said plurality of delivery regions including at least a first delivery region, said first delivery region containing said first delivery destination, a second delivery region, said second delivery region containing said second delivery destination, and a third delivery region, said third delivery region containing a third delivery destination, at least one of said plurality of delivery regions being assigned to at least one of said plurality of delivery vehicles, said first delivery region being assigned to said first delivery vehicle, said second delivery region being assigned to said second delivery vehicle, and said third delivery region being assigned to said third delivery vehicle, said plurality of delivery regions being defined by said central server based on analysis of said group of registered users, said plurality of current ordered items, said plurality of past ordered items, said plurality of delivery vehicles, said plurality of delivery routes, said expected item, a part thereof, or a combination thereof, according to said algorithm;
developing a central database, said central database being a single central database or a plurality of decentralized database, said central database containing at least said algorithm, said group of registered users, said plurality of current ordered items, said plurality of past ordered items, said expected item, said central pick up location, said plurality of delivery vehicles, said plurality of delivery routes, and said plurality of delivery regions.

88. The delivery load management method of claim 87, wherein said central server is capable of predicting a first new order, from said group of registered users within a first per-defined period of time after said first delivery vehicle left said central pick up location with said first ordered item and said expected item, for said expected item with a first expected delivery destination, said first expected delivery destination being within or close by said first delivery region, and a first expected delivery time window, said first expected delivery time window being close to or within said first delivery time window, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

89. The delivery load management method of claim 87, wherein said central server receives a second new order, from said group of registered users within a second per-defined period of time after said first delivery vehicle left said central pick up location with said first ordered item and said expected item, for said expected item with a second expected delivery destination, said second expected delivery destination being within or close by said first delivery region, and a second expected delivery time window, said second expected delivery time window being close to or within said first delivery time window, updates said central database, and modifies said first delivery route to accomplish delivery of said first delivery item to said first delivery destination within said first delivery time window and said expected item to said second expected delivery destination within said second expected delivery time window, based on analysis of said group of registered users, said plurality of current ordered items, said plurality of past ordered items, said central pick up location, said plurality of delivery vehicles, said plurality of delivery routes, said plurality of delivery regions, said real-time location information from said on-board GPS device, said central database, a part thereof, or a combination thereof, according to said algorithm.

90. The delivery load management method of claim 87, wherein said central server instructs said second delivery vehicle to either meet said third delivery vehicle to unload said second expected item to said third delivery vehicle, or return to said central pick up location to unload said expected item, or to a new destination, upon completion of delivery of said second ordered item on board said second delivery vehicle, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

91. The delivery load management method of claim 87 wherein said central server determines volume and identity of said expected item to be carried by each of said plurality of delivery vehicles, said expected item to be carried by each of said plurality of delivery vehicles being identical, different, or a combination thereof, based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.

92. The delivery load management method of claim 87, wherein said algorithm can be improved and modified either manually by a central administrator of said central server or automatically by said central server based on analysis of said group of registered users, said plurality of current ordered items, said plurality of past ordered items, said central pick up location, said plurality of delivery vehicles, said plurality of delivery routes, said plurality of delivery regions, said central database, a part thereof, or a combination thereof, according to said algorithm.
